(19) United States
(12) Patent Application Publication
(10) Pub. No.: US 2026/0268582 A1
(43) Pub. Date: Sep. 10, 2026

(54) THREE-DIMENSIONAL SCENE UNDERSTANDING USING SPARSE TEMPORAL REPRESENTATIONS

(71) Applicant: Applied Intuition, Inc., Sunnyvale, CA (US)

(72) Inventors: Jinhyung Park, Pittsburgh, PA (US); Ryan Patrick Brigden, San Francisco, CA (US); Wei Zhan, Fremont, CA (US); Yihan Hu, San Jose, CA (US); Chensheng Peng, Santa Clara, CA (US)

(21) Appl. No.: 19/558,188

(22) Filed: Mar. 5, 2026

Related U.S. Application Data
(60) Provisional application No. 63/768,111, filed on Mar. 6, 2025.

(51) Int. Cl. G06T 15/08; G06V 20/70

(52) U.S. Cl. CPC G06T 15/08; G06V 20/70

(57) ABSTRACT

Various aspects of the subject technology relate to methods, systems, and machine-readable media for generating semantic scene representations using sparse three-dimensional queries. Various aspects may include receiving, at a first timestep, images captured from cameras that observe a three-dimensional scene. Aspects may also include accessing a queue of previously generated sparse three-dimensional queries propagated from preceding timesteps. Aspects may also include forming, based on the previously generated queries, current sparse three-dimensional queries representing the scene at the first timestep. Aspects may also include iteratively refining, based on the images and previously generated queries, the current queries. Aspects may also include determining, based on the current queries, three-dimensional Gaussian primitives. Aspects may also include generating, based on the Gaussian primitives, a semantic representation of the scene. Aspects may also include propagating at least a subset of the current queries to the queue of the previously generated queries for a second timestep.

### CROSS-REFERENCE TO RELATED APPLICATIONS

The present application claims the benefit of priority under 35 U.S.C. § 119 (e) from U.S. Provisional Patent Application Ser. No. 63/768,111 entitled “STREAMING OCCUPANCY PREDICTION USING SPARSE THREE-DIMENSIONAL QUERIES,” filed on Mar. 6, 2025, the disclosure of which is hereby incorporated by reference in its entirety for all purposes.

### TECHNICAL FIELD

The present disclosure generally relates to three-dimensional scene understanding and representation. More particularly, the present disclosure relates to techniques for generating and updating three-dimensional semantic scene representations using sparse internal representations derived from multi-view image data over time.

### BACKGROUND

Three-dimensional scene understanding and representation are foundational capabilities in numerous technological domains. Such capabilities enable systems to perceive, interpret, and interact with physical environments by constructing digital representations of spatial geometry, object locations, and semantic properties of surrounding regions. As computational systems increasingly operate in complex real-world settings, the ability to efficiently generate and update three-dimensional semantic scene representations from sensor data has become essential.

Applications for three-dimensional scene understanding span diverse fields. By way of non-limiting examples, in automated vehicle navigation, systems rely on continuous spatial awareness to identify drivable surfaces, detect obstacles, and predict the motion of dynamic objects. In robotics, mobile platforms operating in warehouses, hospitals, or domestic environments require detailed spatial maps to plan collision-free paths and manipulate objects. Augmented reality systems overlay digital content onto physical spaces by maintaining accurate three-dimensional models of the surroundings of a user. Similarly, surveillance and security systems benefit from the ability to detect and classify objects within monitored regions. Industrial automation leverages three-dimensional scene understanding for quality inspection, bin picking, and assembly operations. In the medical field, surgical robots and imaging systems utilize spatial representations to navigate complex anatomical structures.

Traditional approaches to three-dimensional scene representation include voxel-based methods, which discretize space into regular three-dimensional grids, and point-based methods, which represent surfaces as collections of discrete spatial coordinates. More recently, continuous representations using learned features have emerged, offering flexibility in modeling complex geometries and semantic attributes. The selection of representation affects computational efficiency, memory requirements, and the fidelity with which a system can capture fine-grained spatial and semantic details.

Multi-view imaging systems, which capture visual data from multiple viewpoints simultaneously or over time, provide rich information for constructing three-dimensional scene representations. Extracting geometric and semantic information from such image sequences involves processing temporal data, fusing observations across viewpoints, and maintaining consistent representations as the observing platform or observed objects move. The computational demands of these operations, particularly in real-time applications, present ongoing challenges.

### SUMMARY

The subject disclosure provides for a real-time three-dimensional scene understanding system that incrementally builds and updates a representation of an environment over time using image data from multiple viewpoints. The system maintains a compact internal representation that is continuously refined to generate a dense three-dimensional description of the scene. Portions of the representation may be retained and updated across successive timesteps.

According to certain embodiments of the present disclosure, a computer-implemented method is provided for training a vision-based three-dimensional perception system using sparse three-dimensional queries. The computer-implemented method may include initializing, by a perception system, a plurality of sparse three-dimensional queries. Each sparse three-dimensional query may include a query location and a latent feature representation. The computer-implemented method may include iteratively refining, based on image features extracted from multi-camera image sequences and based on query information propagated from one or more previous timesteps, the plurality of sparse three-dimensional queries. The computer-implemented method may include determining, based on the plurality of sparse three-dimensional queries, one or more first parameters of a plurality of three-dimensional Gaussian primitives associated with the plurality of the sparse three-dimensional queries. The computer-implemented method may include computing a first objective that supervises geometric alignment of the plurality of the sparse three-dimensional queries with a structure of a three-dimensional scene. The computer-implemented method may include updating, based on the first objective, one or more second parameters of the perception system. The computer-implemented method may include computing a second objective that supervises a three-dimensional semantic scene representation derived from the plurality of three-dimensional Gaussian primitives. The computer-implemented method may include updating, based on the second objective, the one or more second parameters of the perception system.

According to another embodiment of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to perform operations. The operations may include initializing, by a perception system, a plurality of sparse three-dimensional queries. Each sparse three-dimensional query may include a query location and a latent feature representation. The operations may include iteratively refining, based on image features extracted from multi-camera image sequences and based on query information propagated from one or more previous timesteps, the plurality of sparse three-dimensional queries. The operations may include determining, based on the plurality of sparse three-dimensional queries, one or more first parameters of a plurality of three-dimensional Gaussian primitives associated with the plurality of the sparse three-dimensional queries. The operations may include computing a first objective that supervises geometric alignment of the plurality of the sparse three-dimensional queries with a structure of a three-dimensional scene. The operations may include updating, based on the first objective, one or more second parameters of the perception system. The operations may include computing a second objective that supervises a three-dimensional semantic scene representation derived from the plurality of three-dimensional Gaussian primitives. The operations may include updating, based on the second objective, the one or more second parameters of the perception system.

According to yet other embodiments of the present disclosure, a non-transitory computer-readable storage medium including computer-readable instructions embodied therein, which when executed by one or more processors, cause a computer system to perform operations, is provided. The operations may include initializing, by a perception system, a plurality of sparse three-dimensional queries. Each sparse three-dimensional query may include a query location and a latent feature representation. The operations may include iteratively refining, based on image features extracted from multi-camera image sequences and based on query information propagated from one or more previous timesteps, the plurality of sparse three-dimensional queries. The operations may include determining, based on the plurality of sparse three-dimensional queries, one or more first parameters of a plurality of three-dimensional Gaussian primitives associated with the plurality of the sparse three-dimensional queries. The operations may include computing a first objective that supervises geometric alignment of the plurality of the sparse three-dimensional queries with a structure of a three-dimensional scene. The operations may include updating, based on the first objective, one or more second parameters of the perception system. The operations may include computing a second objective that supervises a three-dimensional semantic scene representation derived from the plurality of three-dimensional Gaussian primitives. The operations may include updating, based on the second objective, the one or more second parameters of the perception system.

According to certain embodiments of the present disclosure, a computer-implemented method is provided for generating semantic scene representations using sparse three-dimensional queries. The computer-implemented method may include receiving, at a first timestep, multi-camera image data captured from a plurality of cameras that observe a three-dimensional scene. The computer-implemented method may include accessing a queue of previously generated sparse three-dimensional queries propagated from one or more previous timesteps preceding the first timestep. Each previously generated sparse three-dimensional query may include a query location and a latent feature representation. The computer-implemented method may include forming, based on the previously generated sparse three-dimensional queries, a plurality of current sparse three-dimensional queries representing the three-dimensional scene at the first timestep. The computer-implemented method may include iteratively refining, based on the multi-camera image data and the previously generated sparse three-dimensional queries, the plurality of current sparse three-dimensional queries. The computer-implemented method may include determining, based on the plurality of current sparse three-dimensional queries, a plurality of three-dimensional Gaussian primitives. The computer-implemented method may include generating, based on the plurality of three-dimensional Gaussian primitives, a semantic representation of the three-dimensional scene. The computer-implemented method may include propagating at least a subset of the plurality of current sparse three-dimensional queries to the queue of the previously generated sparse three-dimensional queries for a second timestep.

According to another embodiment of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to perform operations. The operations may include receiving, at a first timestep, multi-camera image data captured from a plurality of cameras that observe a three-dimensional scene. The operations may include accessing a queue of previously generated sparse three-dimensional queries propagated from one or more previous timesteps preceding the first timestep. Each previously generated sparse three-dimensional query may include a query location and a latent feature representation. The operations may include forming, based on the previously generated sparse three-dimensional queries, a plurality of current sparse three-dimensional queries representing the three-dimensional scene at the first timestep. The operations may include iteratively refining, based on the multi-camera image data and the previously generated sparse three-dimensional queries, the plurality of current sparse three-dimensional queries. The operations may include determining, based on the plurality of current sparse three-dimensional queries, a plurality of three-dimensional Gaussian primitives. The operations may include generating, based on the plurality of three-dimensional Gaussian primitives, a semantic representation of the three-dimensional scene. The operations may include propagating at least a subset of the plurality of current sparse three-dimensional queries to the queue of the previously generated sparse three-dimensional queries for a second timestep.

According to yet other embodiments of the present disclosure, a non-transitory computer-readable storage medium including computer-readable instructions embodied therein, which when executed by one or more processors, cause a computer system to perform operations, is provided. The operations may include receiving, at a first timestep, multi-camera image data captured from a plurality of cameras that observe a three-dimensional scene. The operations may include accessing a queue of previously generated sparse three-dimensional queries propagated from one or more previous timesteps preceding the first timestep. Each previously generated sparse three-dimensional query may include a query location and a latent feature representation. The operations may include forming, based on the previously generated sparse three-dimensional queries, a plurality of current sparse three-dimensional queries representing the three-dimensional scene at the first timestep. The operations may include iteratively refining, based on the multi-camera image data and the previously generated sparse three-dimensional queries, the plurality of current sparse three-dimensional queries. The operations may include determining, based on the plurality of current sparse three-dimensional queries, a plurality of three-dimensional Gaussian primitives. The operations may include generating, based on the plurality of three-dimensional Gaussian primitives, a semantic representation of the three-dimensional scene. The operations may include propagating at least a subset of the plurality of current sparse three-dimensional queries to the queue of the previously generated sparse three-dimensional queries for a second timestep.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a network architecture suitable for generating three-dimensional semantic scene representations using sparse temporal representations, according to certain aspects of the present disclosure;

FIG. 2 is a block diagram illustrating details of a client device and a server used in a network architecture as disclosed herein, according to certain aspects of the present disclosure;

FIG. 3 is a block diagram illustrating an example system with which aspects of the subject technology may be implemented, according to certain aspects of the present disclosure;

FIG. 4 is a block diagram illustrating an example streaming perception architecture for refining sparse three-dimensional queries using image features and temporal information to produce scene outputs and propagated queries, according to certain aspects of the present disclosure;

FIG. 5 is a schematic diagram illustrating an example query structure and a derivation of multiple Gaussian primitives from the query structure, according to certain aspects of the present disclosure;

FIG. 6 illustrates an example process for streaming query generation and refinement over discrete timesteps, according to certain aspects of the present disclosure;

FIG. 7 illustrates an exemplary workflow for a process for training a vision-based three-dimensional perception system using sparse three-dimensional queries, according to certain aspects of the present disclosure;

FIG. 8 illustrates an exemplary workflow for a process for generating semantic scene representations using sparse three-dimensional queries, according to certain aspects of the present disclosure; and

FIG. 9 is a block diagram illustrating an exemplary computer system with which aspects of the subject technology may be implemented, according to certain aspects of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, any drawings and descriptions are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

Three-dimensional scene understanding and representation are foundational capabilities in numerous technological domains. Such capabilities enable systems to perceive, interpret, and interact with physical environments by constructing digital representations of spatial geometry, object locations, and semantic properties of surrounding regions. As computational systems increasingly operate in complex real-world settings, the ability to efficiently generate and update three-dimensional semantic scene representations from sensor data has become essential. Applications for three-dimensional scene understanding span diverse fields, such as automated vehicle navigation; robotics; mobile platforms; augmented reality systems; surveillance and security systems; industrial automation; and the medical field.

Traditional approaches to three-dimensional scene representation include voxel-based methods, which discretize space into regular three-dimensional grids, and point-based methods, which represent surfaces as collections of discrete spatial coordinates. More recently, continuous representations using learned features have emerged, offering flexibility in modeling complex geometries and semantic attributes. The selection of representation affects computational efficiency, memory requirements, and the fidelity with which a system can capture fine-grained spatial and semantic details. Multi-view imaging systems, which capture visual data from multiple viewpoints simultaneously or over time, provide rich information for constructing three-dimensional scene representations. Extracting geometric and semantic information from such image sequences involves processing temporal data, fusing observations across viewpoints, and maintaining consistent representations as the observing platform or observed objects move. The computational demands of these operations, particularly in real-time applications, present ongoing challenges.

Existing approaches for three-dimensional semantic occupancy prediction represent the entire spatial volume as a grid of voxels, requiring computation across hundreds of thousands of voxel locations even when large portions of the scene are empty or unoccupied. Such a dense representation may impose substantial memory overhead and processing time, limiting the ability of such systems to operate at the frame rates required for real-time applications. Dense Gaussian-based methods similarly face scalability challenges, often requiring many thousand Gaussian primitives to represent an environment. Such methods rely on local sparse convolutions because global feature interaction among such a large number of primitives becomes computationally prohibitive. Furthermore, both voxel-based and dense Gaussian approaches may struggle to effectively integrate temporal information across successive frames. Existing temporal fusion strategies often warp or project features from previous frames into the current frame, but such operations may introduce artifacts when applied to dense grids and may incur unnecessary computation in regions of space that remain unoccupied over time. The inflexibility of dense representations in capturing temporal dynamics may result in reduced accuracy for modeling moving objects and static infrastructure over extended time horizons.

The technical problem presented by prior three-dimensional scene representation methods is the inability to achieve both high-fidelity spatial and semantic scene understanding and real-time computational efficiency while maintaining accurate temporal consistency across successive observations. Solving the technical problem requires a representation that is sufficiently sparse to minimize computational overhead, sufficiently expressive to capture fine-grained geometric and semantic details, and sufficiently flexible to propagate and update scene information over time without incurring the costs associated with dense spatial grids or large collections of primitives.

As disclosed herein, novel techniques represent a significant advancement in the field of three-dimensional perception technology by providing for generation and updating of semantic scene representations using sparse three-dimensional queries that are temporally propagated and decoded into three-dimensional Gaussian primitives. The techniques disclosed herein address the aforementioned technical problem by maintaining a compact set of sparse three-dimensional queries that encode spatial and semantic properties of a scene, propagating the sparse three-dimensional queries across successive timesteps to incorporate temporal information, and decoding each sparse three-dimensional query into a plurality of three-dimensional Gaussian primitives. The decoded three-dimensional Gaussian primitives provide a geometric representation suitable for conversion into a dense semantic scene representation while preserving a sparse internal structure for temporal processing.

In some embodiments, a perception system may refer to a computing system configured to receive sensor data and to generate, maintain, and update a three-dimensional semantic representation of an environment based on the sensor data over time. The perception system may receive, at a timestep, multi-camera image data and access a queue of previously generated sparse three-dimensional queries propagated from one or more previous timesteps. Each query may include a query location in three-dimensional space and a latent feature representation. The perception system may form a set of current sparse three-dimensional queries by combining the previously generated queries with newly initialized queries, and the perception system may iteratively refine the current queries based on image features extracted from the multi-camera data and based on temporal information carried by the previously generated queries. Each refined query may be decoded into multiple three-dimensional Gaussian primitives (or, Gaussians), wherein each Gaussian primitive may include at least a location, a scale, a rotation, and an opacity. The perception system may generate a semantic representation of the scene by splatting the Gaussian primitives onto a voxel grid, computing for each voxel location an occupancy probability and a semantic class distribution based on contributions from nearby Gaussians. A subset of the current queries may be selected for propagation to a subsequent timestep based on a confidence measure such as query opacity. Spatial separation may be enforced between selected queries to maintain diversity. The perception system may compensate for observer motion by transforming query locations across coordinate frames, and the perception system may determine query velocities to model motion of dynamic objects across successive timesteps.

Training of the disclosed perception system may involve a multi-stage process. In a first stage, the perception system may be trained to capture three-dimensional scene geometry by initializing queries at noised three-dimensional point locations (for example, noised light detection and ranging (LiDAR) points), refining the queries based on image features, decoding the queries into Gaussian primitives, and computing a first objective that supervises geometric alignment of the queries and Gaussians with the structure of the scene. The first objective may include at least one of a denoising loss that supervises movement of queries from empty regions toward occupied regions, a depth rendering loss that compares rendered depth maps to observed depth maps, and a color rendering loss that compares rendered color images to observed images. The perception system may propagate queries and Gaussians to neighboring timesteps using predicted query velocities and may supervise the rendered outputs at the neighboring timesteps while accounting for observer motion. In a second stage, the system may be trained for three-dimensional semantic occupancy prediction by computing a second objective that supervises a semantic scene representation derived from the Gaussian primitives, wherein each Gaussian primitive may include a semantic class label and Gaussian primitives derived from the same query may share a common semantic class label. The perception system may initialize queries at learnable or predefined locations during the second stage, and the perception system may update system parameters based on the second objective after having updated parameters based on the first objective in the first stage.

Accordingly, the techniques disclosed herein provide a technical framework for generating and maintaining three-dimensional semantic scene representations using a compact internal representation that is updated over time. By organizing scene information into a set of sparse three-dimensional queries that are refined, propagated, and decoded into geometric primitives, the framework supports efficient processing of multi-view image data while preserving spatial and semantic structure. The hierarchical decoding of sparse queries into multiple three-dimensional Gaussian primitives enables localized representation of scene detail while maintaining a sparse high-level representation suitable for temporal propagation. The use of staged training objectives facilitates learning of three-dimensional geometry prior to semantic modeling, and the conversion of geometric primitives into voxel-aligned semantic outputs supports interoperability with downstream components that operate on dense representations.

### Example System Architecture

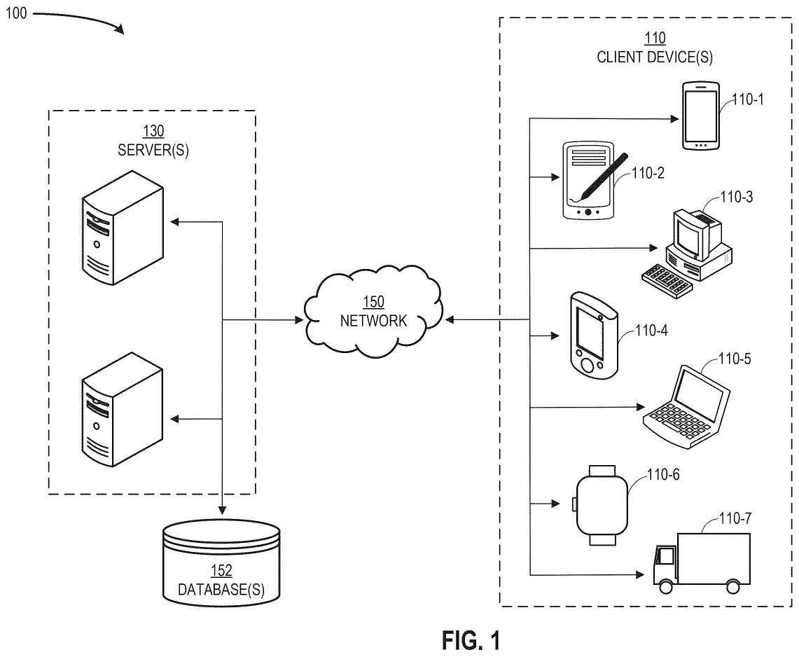

FIG. 1 illustrates a network architecture 100 suitable for generating three-dimensional semantic scene representations using sparse temporal representations, according to certain aspects of the present disclosure. Architecture 100 may include server(s) 130 and database 152, communicatively coupled with one or more client device(s) 110 via network 150.

Client device(s) 110 may include any one of laptop computer 110-5, desktop computer 110-3, or a mobile device such as smartphone 110-1, palm device 110-4, tablet device 110-2, or the like. In some embodiments, client device(s) 110 may include wearable device 110-6 (for example, a smart watch, a smart bracelet, an extended reality (XR) head-mounted display (HMD)). In some embodiments, client device(s) 110 may include automated vehicle (AV) 110-7. Client device(s) 110 may include a user interface that may allow a user to interact with a three-dimensional perception system. Client device(s) 110 may be configured with a web browser or a dedicated application to facilitate communication with server(s) 130.

Server(s) 130 may include a computing device or a cluster of computing devices that may host a platform, service, or application running on client device(s) 110 used by one or more of the participants in the network. Server(s) 130 may include a cloud server or a group of cloud servers. In some implementations, server(s) 130 may not be cloud-based (that is, platforms/applications may be implemented outside of a cloud computing environment) or may be partially cloud-based. Some or all of server(s) 130 may be part of a cloud computing server, including but not limited to rack-mounted computing devices and panels. Such panels may include but are not limited to processing boards, switchboards, routers, and other network devices. In some embodiments, server(s) 130 may include client device(s) 110 as well, such that server(s) 130 and client device(s) 110 are peers. Server(s) 130 may be configured to receive requests from a client device (for example, client device(s) 110), process the requests, and send appropriate responses back to the client device. Server(s) 130 may include a database (for example, database(s) 152), for storing data and files associated with server(s) 130 and/or client device(s) 110.

Database(s) 152 may store backup files required to run software including, for example, specific operating systems, CPU types, or installed software libraries that enable the execution of various programs on server(s) 130 and/or client device(s) 110. Database(s) 152 may logically form a single unit or may be part of a distributed computing environment encompassing multiple computing devices that are located within their corresponding server, located at the same, or located at geographically disparate physical locations. For example, various information related to three-dimensional scene representations, sparse three-dimensional queries, query features, Gaussian primitives, semantic labels, image data, or the like may be stored in database(s) 152.

Network 150 may include a wired network (for example, fiber optics, copper wire, telephone lines, or the like) and/or a wireless network (for example, satellite network, cellular network, radiofrequency (RF) network, Wi-Fi, Bluetooth, or the like). Network 150 may include, for example, any one or more of a local area network (LAN), a wide area network (WAN), the Internet, a mesh network, a hybrid network, or other wired or wireless networks. Further, network 150 may include, but is not limited to, any one or more of the following network topologies, including a bus network, a star network, a ring network, a mesh network, a star-bus network, tree or hierarchical network, and the like. Network 150 may be the Internet or some other public or private network. Client computing devices may be connected to network 150 through a network interface, such as by wired or wireless communication. The connections may be any kind of local, wide area, wired, or wireless network, including network 150 or a separate public or private network.

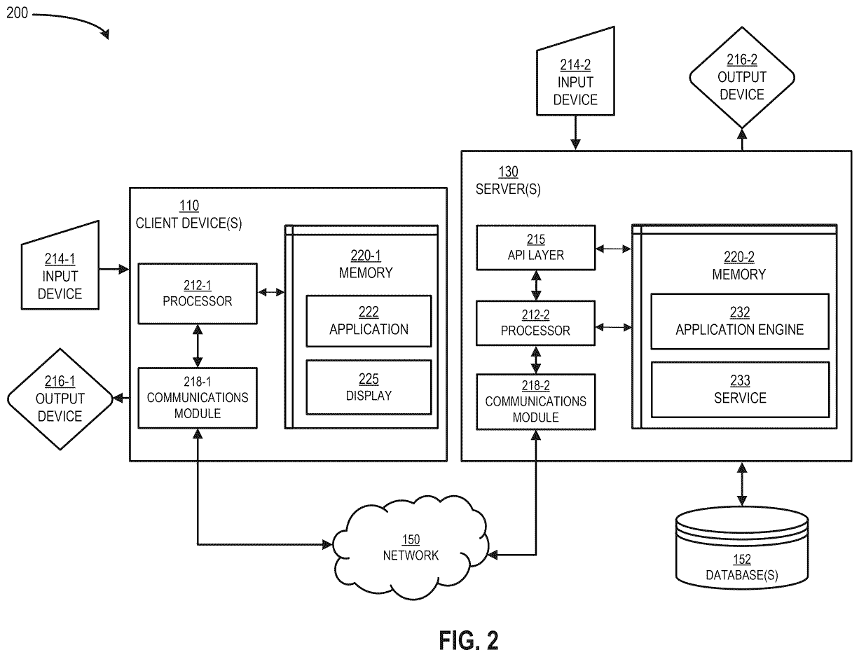

FIG. 2 is a block diagram 200 illustrating details of client device(s) 110 and server(s) 130 used in a network architecture as disclosed herein (for example, architecture 100), according to certain aspects of the present disclosure. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to transmit or receive information, such as user data, image data, query data, three-dimensional scene data, semantic labels, software updates, or the like. Communications modules 218 may use hardware such as, for example, modems or Ethernet cards, and may include radio hardware and software for wireless communications (for example, via electromagnetic radiation, such as radiofrequency (RF), near field communications (NFC), Wi-Fi, or Bluetooth radio technology).

Client device(s) 110 and server(s) 130 may each be coupled to at least one input device 214-1 and input device 214-2, respectively (hereinafter, collectively referred to as “input device(s) 214”). Input device(s) 214 may include a mouse, a keyboard, a pointer, a touchscreen, a wearable input device (for example, a haptics glove, a bracelet, a ring, an earring, a necklace, a watch, or the like), a microphone, a controller, a joystick, a virtual joystick, a camera, a touchscreen display, or the like. In some embodiments, input device(s) 214 may include cameras, microphones, sensors, or the like. In some embodiments, the sensors may include touch sensors, acoustic sensors, inertial motion units (IMUs), light detection and ranging (LiDAR) sensors, or other sensors configured to provide input data.

In further examples, input device(s) 214 may include biometric components, motion components, environmental components, or position components, among a wide array of other components. Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

Client device(s) 110 and server(s) 130 may each be also coupled to at least one output device 216-1 and output device 216-2, respectively (hereinafter, collectively referred to as “output device(s) 216”). Output device(s) 216 may include a display screen (for example, a same touchscreen display used as an input device), such as a liquid crystal display (LCD) screen and/or light emitting diode (LED) display screen. Output device(s) 216 may include a speaker, an alarm, a projector, a holographic or augmented reality display (for example, a heads-up display device or a head-mounted device), and the like. A user may interact with client device(s) 110 and/or server(s) 130 via input device(s) 214 and output device(s) 216.

In various implementations, client device(s) 110 may communicate over wired or wireless channels to distribute processing and/or share data. Architecture 100 may create, administer, or provide interaction modes for a shared artificial reality environment (for example, a collaborative artificial reality environment) at client device(s) 110, such as for communication via extended reality (XR) or other communication elements. The interaction modes may include various modes for various audio conversation, textual input/output, communicative gestures, control modes, and other communicative interaction, etc., for each user of client device(s) 110.

Client device(s) 110 may also include processor 212-1, configured to execute instructions stored in memory 220-1, and to cause client device(s) 110 to perform at least some operations in methods consistent with one or more embodiments. Some operations may be offloaded to a core processing component or to server(s) 130. Memory 220-1 may further include application 222 and display 225, configured to run in client device(s) 110 and couple with input device(s) 214 and output device(s) 216. Application 222 may be downloaded by a user from server(s) 130 or may be hosted by server(s) 130. Application 222 may include specific instructions which, when executed by processor 212-1, cause operations to be performed according to methods described herein. In some embodiments, application 222 may run on a platform, for example, an operating system (OS) installed in client device(s) 110. In some embodiments, application 222 may run out of a web browser. In some embodiments, processor 212-1 may be configured to control a graphical user interface (GUI) (for example, spanning at least a portion of input device(s) 214 and output device(s) 216) for a user of client device(s) 110 to access server(s) 130.

Data and files associated with application 222 may be stored in database(s) 152. Application 222 may communicate with service 233 in memory 220-2 to provide three-dimensional semantic scene representation data for perception operations. Application 222 may communicate with service 233 through application programming interface (API) layer 215, for example, of server(s) 130.

Server(s) 130 may include memory 220-2, processor 212-2, and communications module 218-2. Hereinafter, processors 212-1 and 212-2, and memories 220-1 and 220-2, will be collectively referred to, respectively, as “processors 212” and “memories 220.” In some implementations, server(s) 130 may be used as part of a network or platform implemented via network 150. Processors 212 (for example, CPUs, GPUs, holographic processing units (HPUs), etc.) may be configured to execute instructions stored in memories 220. Processors 212 may be a single processing unit or multiple processing units in a device or distributed across multiple devices (for example, distributed across two or more of client device(s) 110). Processors 212 may be coupled to other hardware devices, for example, with the use of an internal or external bus, such as a peripheral component interconnect (PCI) bus, small computer system interface (SCSI) bus, wireless connection, and/or the like. Processors 212 may communicate with a hardware controller for devices, such as input device(s) 214 and output device(s) 216.

Memories 220 may include one or more hardware devices for volatile or non-volatile storage, and memories 220 may include both read-only and writable memory. For example, a memory may include one or more of random-access memory (RAM), various caches, CPU registers, read-only memory (ROM), and writable non-volatile memory, such as flash memory, hard drives, floppy disks, CDs, DVDs, magnetic storage devices, tape drives, and so forth. Memories 220 may not propagate signals divorced from underlying hardware; thus, a memory may be non-transitory. Memories 220 may include program memory that stores programs or software. Memories 220 may also include data memory that may include information to be provided to the program memory or any element of the network.

Memory 220-2 may include application engine 232. Application engine 232 may be configured to perform methods or operations consistent with embodiments of the present disclosure. Application engine 232 may share or provide features and resources to client device(s) 110, including data, libraries, and/or applications retrieved with application engine 232 (for example, application 222), including multiple tools associated with query initialization, query refinement, Gaussian primitive generation, semantic scene representation, and three-dimensional occupancy prediction operations. Such tools may support perception applications that use sparse three-dimensional queries, Gaussian primitives, or semantic scene representations retrieved (for example, at application 222) for content rendering to a user of client device(s) 110. This may enable the platform to present three-dimensional scene visualizations, occupancy predictions, or other relevant content effectively to the user. The user may access application engine 232 through application 222, installed in memory 220-1 of client device(s) 110. Application 222 may be installed in client device(s) 110 by application engine 232 and/or may execute scripts, routines, programs, applications, and the like provided by application engine 232. Application engine 232 may include one or more sets of machine-readable instruction modules that, when executed by processors 212, are configured to perform operations according to one or more aspects of embodiments described herein.

Some implementations may be operational with numerous other computing system environments or configurations. Examples of computing systems, environments, and/or configurations that may be suitable for use with the technology include, but are not limited to, automated vehicles, wearable devices, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

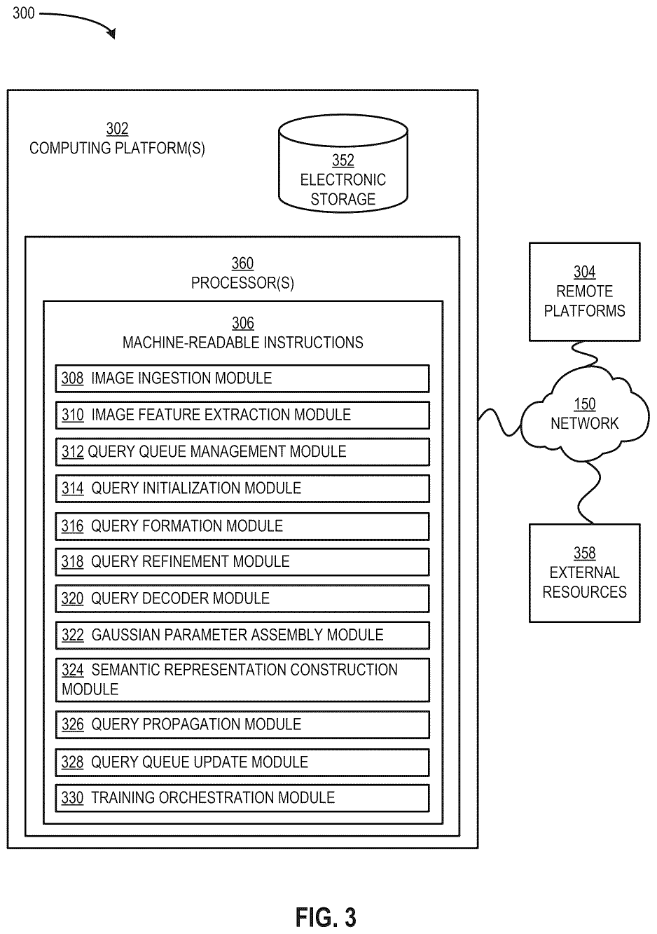

FIG. 3 is a block diagram illustrating an example system 300 (for example, representing both client and server) with which aspects of the subject technology may be implemented, according to certain aspects of the present disclosure. System 300 may be configured to provide for generating three-dimensional semantic scene representations using sparse temporal representations. In some implementations, system 300 may include one or more computing platform(s) 302. For example, computing platform(s) 302 may be configured to execute software algorithm(s) to encode, compress, decompress, or reconstruct text or image data.

Computing platform(s) 302 may maintain or store data, such as in electronic storage 352, including correlation, contextual data, or metadata used by computing platform(s) 302. Computing platform(s) 302 may be configured to communicate with one or more remote platform(s) 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300, which may host one or more application(s), for example, via remote platform(s) 304. In this way, remote platform(s) 304 may be configured to cause output of system 300 on client device(s) of remote platform(s) 304 with enabled access (for example, based on analysis by computing platform(s) 302, according to the stored data).

Computing platform(s) 302 may be configured by machine-readable instructions 306. Machine-readable instructions 306 may be executed by computing platform(s) 302 to implement one or more instruction modules. The instruction modules may include computer program modules. The instruction modules being implemented may include one or more of image ingestion module 308, image feature extraction module 310, query queue management module 312, query initialization module 314, query formation module 316, query refinement module 318, query decoder module 320, gaussian parameter assembly module 322, semantic representation construction module 324, query propagation module 326, query queue update module 328, and training orchestration module 330.

Image ingestion module 308 may be configured to receive and preprocess multi-camera image sequences that capture views of a three-dimensional scene. In some embodiments, image ingestion module 308 may receive image data from a plurality of cameras mounted on an automated vehicle, robotic platform, augmented reality device, or other mobile system. Each camera may capture a different spatial region or viewing angle of the surrounding environment. For example, an automated vehicle may include six cameras positioned to provide surround-view coverage, including front, rear, left side, right side, and additional oblique or upward-facing cameras. Image ingestion module 308 may receive raw image frames from cameras at a specified frame rate, such as 10 hertz (Hz), 20 Hz, or 30 Hz, depending on the operational requirements of the perception system. In some embodiments, image ingestion module 308 may perform initial preprocessing operations on received image data, such as resizing images to a predetermined resolution (for example, 256 pixels by 704 pixels), normalizing pixel intensity values, applying color corrections, or compensating for lens distortion. In some embodiments, cameras may have non-identical capture timing. In some embodiments, image ingestion module 308 may synchronize image frames captured by different cameras at substantially the same timestep, aligning image data temporally to facilitate subsequent multi-view processing. In some embodiments, image ingestion module 308 may buffer incoming image sequences to accommodate variable processing rates downstream, maintaining a rolling window of recent image frames for temporal context. Image ingestion module 308 may further annotate each image frame with metadata, such as capture timestamp, camera identifier, intrinsic camera parameters (for example, focal length, principal point), and extrinsic camera parameters (for example, position and orientation relative to a reference coordinate frame). In some embodiments, image ingestion module 308 may interface with external data sources, such as inertial measurement units (IMUs), global positioning system (GPS) receivers, or other motion sensors, to obtain observer motion information that may be used to compensate for platform movement across successive timesteps. Image ingestion module 308 may output preprocessed image data and associated metadata to downstream modules for feature extraction and query refinement operations.

Image feature extraction module 310 may be configured to extract multi-scale image features from preprocessed multi-camera image sequences received from an image ingestion module (for example, image ingestion module 308). In some embodiments, image feature extraction module 310 may employ one or more deep neural network backbones to generate hierarchical feature representations from each image frame. Image feature extraction module 310 may process image data from each camera view through a sequence of convolutional, pooling, or normalization operations to produce feature maps at multiple spatial resolutions. In some embodiments, image feature extraction module 310 may extract features at different scales to capture both coarse spatial context and fine-grained visual detail present in the scene. The extracted image features may encode appearance information, structural cues, and semantic patterns associated with observed image content. In some embodiments, parameters of the feature extraction backbone may be initialized using pretrained weights obtained from large-scale image datasets or domain-specific datasets, and training of image feature extraction module 310 may include application of data augmentation techniques to improve robustness. In some embodiments, image feature extraction module 310 may incorporate additional architectural components, such as feature pyramid structures or attention-based processing, to facilitate aggregation of information across spatial scales or image regions. Image feature extraction module 310 may output the extracted image features to a query refinement module (for example, query refinement module 318). The extracted image features may serve as visual inputs that support updating of latent representations of sparse three-dimensional queries based on observed image content at a given timestep.

Query queue management module 312 may be configured to maintain and manage a temporal queue of sparse three-dimensional queries that persist across successive timesteps of operation of a perception system. The temporal queue may store query representations generated at one or more prior timesteps and may provide access to such representations for use in forming and refining a current set of sparse three-dimensional queries. Each sparse three-dimensional query stored in the temporal queue may include a query location in three-dimensional space and an associated latent feature representation that encodes information about a corresponding region of a scene. In some embodiments, query queue management module 312 may organize the temporal queue as a rolling buffer or other ordered data structure that maintains a bounded number of historical query sets. The temporal queue may be managed according to a configurable policy, such as a fixed maximum length or a time-based retention criterion, and queries associated with older timesteps may be removed as newer queries are appended. Such queue management may enable the perception system to balance retention of temporal context with computational and memory constraints, while preserving access to recently observed scene information.

In some embodiments, query queue management module 312 may apply observer-motion compensation to sparse three-dimensional queries stored in the temporal queue. Observer-motion compensation may include transforming query locations from coordinate frames associated with prior timesteps into a coordinate frame associated with a current timestep. The transformations applied by query queue management module 312 may include rigid transformations, such as translations and rotations, and may be based on motion information provided by external sensors or upstream modules, including but not limited to inertial measurement units, global positioning system receivers, or other motion estimation components. By applying observer-motion compensation, the temporal queue may maintain spatial consistency of query locations relative to the current frame of reference.

In some embodiments, query queue management module 312 may further update query locations based on predicted query velocities associated with the sparse three-dimensional queries. The predicted query velocities may represent motion of corresponding regions of a three-dimensional scene across successive timesteps and may be provided by downstream processing modules. Updating query locations based on predicted query velocities may enable the temporal queue to reflect expected scene dynamics when forming query representations for subsequent processing.

Query queue management module 312 may retrieve sparse three-dimensional queries from the temporal queue for use in forming a current set of queries at a present timestep. The retrieved queries may be provided to downstream modules responsible for query formation or refinement. Query queue management module 312 may also interface with a query queue update module (for example, query queue update module 328) to receive updated sparse three-dimensional queries generated during processing of the current timestep and to append the updated queries to the temporal queue for propagation to future timesteps. Through maintenance, transformation, and controlled updating of the temporal query queue, query queue management module 312 supports continuity of sparse three-dimensional query representations over time within the perception system.

Query initialization module 314 may be configured to initialize one or more sparse three-dimensional queries for a current timestep, including queries that supplement sparse three-dimensional queries propagated from prior timesteps. Each sparse three-dimensional query may include a query location in three-dimensional space and an associated latent feature representation that is usable by downstream modules for refinement and decoding. In some embodiments, query initialization module 314 may initialize query locations within a predefined region of interest in three-dimensional space, wherein the region of interest may be selected based on an expected spatial extent of a scene representation and expressed relative to a reference coordinate frame associated with a sensing platform. Query initialization module 314 may generate query locations using one or more sampling policies, such as random sampling, stratified sampling, or sampling from a learnable set of initialization locations.

In some embodiments, query initialization module 314 may assign an initial latent feature representation to each initialized query location. The initial latent feature representation may be randomly initialized, may be drawn from a distribution learned during training, or may be derived from a learnable embedding table. The dimensionality and parameterization of the latent feature representation may be selected to support subsequent attention-based refinement and decoding operations. Query initialization module 314 may further associate each initialized query with auxiliary metadata usable by downstream modules, such as an identifier indicating that a query is newly initialized for a current timestep, a timestamp, or a query source indicator.

In some embodiments, during a geometry-focused pretraining phase, query initialization module 314 may initialize query locations using three-dimensional point data representing structure of a three-dimensional scene, such as point data obtained from a depth sensor. For example, query initialization module 314 may select a subset of point locations that provide spatial coverage of the scene structure and may perturb the selected point locations with injected noise so that downstream learning objectives train the system to recover aligned query locations through refinement. A selection operation may include furthest-point sampling or another diversity-promoting sampling technique, and a noise injection operation may include adding bounded random perturbations to sampled point coordinates. The initialization strategy may be used to support a denoising objective that supervises movement of queries from less informative regions toward occupied regions of the scene during pretraining.

Query initialization module 314 may output a set of newly initialized sparse three-dimensional queries for a current timestep to a query formation module (for example, query formation module 316). The number of newly initialized queries may be configurable based on compute and fidelity targets and may be varied across operating modes without altering the overall query-based representation framework. By providing newly initialized queries alongside propagated queries, query initialization module 314 supports coverage of scene regions that may not be represented by prior queries.

Query formation module 316 may be configured to form a set of current sparse three-dimensional queries representing a three-dimensional scene at a present timestep by combining sparse three-dimensional queries propagated from one or more prior timesteps with one or more newly initialized sparse three-dimensional queries. The propagated sparse three-dimensional queries may be retrieved from a temporal query queue, and the newly initialized sparse three-dimensional queries may be provided by a query initialization module (for example, query initialization module 314). In some embodiments, query formation module 316 may combine the propagated queries and newly initialized queries by concatenation, interleaving, or another aggregation operation that preserves an association between each query and a corresponding query location and latent feature representation.

In some embodiments, query formation module 316 may form the set of current queries by selecting a subset of propagated queries for inclusion based on a configurable policy. The configurable policy may be based on a confidence signal associated with each propagated query, such as an opacity-related value or another learned confidence metric, and the configurable policy may optionally incorporate a diversity policy that discourages excessive overlap among selected propagated queries. Selection may be performed by ranking, thresholding, greedy selection with spatial separation, or another selection technique. Query formation module 316 may further receive the selected propagated queries after observer-motion compensation has been applied to align query locations to a coordinate frame associated with the present timestep.

In some embodiments, query formation module 316 may distinguish between propagated queries and newly initialized queries by assigning identifiers, tags, or embeddings that encode query provenance, query age, or temporal context. Such identifiers may be used by downstream attention mechanisms to condition interactions among queries or to condition interactions between queries and image features. Query formation module 316 may organize the combined query set as a structured representation suitable for batch processing, for example as one or more tensors that include a query dimension, a spatial coordinate dimension, and a latent feature dimension. Query formation module 316 may optionally apply normalization or embedding operations to the latent feature representations to prepare the combined query set for iterative refinement.

In some embodiments, query formation module 316 may incorporate auxiliary information into the combined query set, such as a timestep index, a camera rig identifier, or a region-of-interest descriptor. Query formation module 316 may also support a configuration in which newly initialized queries are placed at learnable locations or predefined locations within a region of interest, enabling repeated use of query anchors that are optimized during training.

Query formation module 316 may output the set of current sparse three-dimensional queries to a query refinement module (for example, query refinement module 318). By combining propagated queries that carry temporal context with newly initialized queries that provide coverage of additional spatial regions, query formation module 316 supports formation of a compact yet adaptive internal representation that is updated on a timestep-by-timestep basis.

Query refinement module 318 may be configured to iteratively refine latent feature representations and query locations of a set of current sparse three-dimensional queries using multi-camera image features and temporal query information. In some embodiments, query refinement module 318 may receive (i) extracted image features derived from multi-camera image data for a present timestep, and (ii) a set of current sparse three-dimensional queries formed from propagated queries and newly initialized queries. Query refinement module 318 may update each query latent feature representation to reflect evidence from image observations and prior query state, and query refinement module 318 may update each query location to improve geometric alignment with occupied regions of a three-dimensional scene.

In some embodiments, query refinement module 318 may implement an attention-based architecture that includes interactions among queries and interactions between queries and image features. Interactions among queries may include self-attention operations that enable information exchange across the query set, supporting global context among a compact number of queries. Interactions between queries and image features may include cross-attention operations in which queries attend to image feature locations that correspond to query locations. In some embodiments, cross-attention may be implemented using deformable attention or another sparse sampling mechanism in which each query attends to a limited set of sampled feature positions rather than a dense set of image pixels.

In some embodiments, to obtain feature samples associated with a query location, query refinement module 318 may project a three-dimensional query location into one or more two-dimensional image planes using camera calibration parameters, including intrinsic parameters and extrinsic parameters. The projected positions may be used to sample from multi-scale feature maps produced by an image feature extraction module (for example, image feature extraction module 310), and sampled features may be aggregated across cameras and across scales. Query refinement module 318 may incorporate positional encodings or coordinate embeddings associated with query locations and feature sample coordinates to provide spatial awareness within attention computations.

In some embodiments, query refinement module 318 may iteratively apply multiple refinement layers, wherein each refinement layer updates query features and optionally updates query locations. Query location updates may be produced as predicted offsets that adjust a query location within three-dimensional space. Query refinement module 318 may also maintain query-associated attributes used by downstream modules, such as an opacity-related confidence signal or a query velocity.

Query refinement module 318 may output refined sparse three-dimensional queries that include updated query locations and updated latent feature representations to a query decoder module (for example, query decoder module 320). By refining a compact set of temporally informed queries using multi-camera image features and attention-based interactions, query refinement module 318 supports a representation that can be decoded into a set of geometric primitives for semantic scene representation generation at each timestep.

Query decoder module 320 may be configured to decode refined sparse three-dimensional queries into parameters usable to define a plurality of three-dimensional Gaussian primitives associated with the refined sparse three-dimensional queries. In some embodiments, query decoder module 320 may receive refined query locations and refined latent feature representations from a query decoder module (for example, query refinement module 318) and may generate query-level outputs that describe a spatial region anchored by each query. Query-level outputs may include a query location offset that adjusts a query anchor, a query opacity that serves as a confidence or density-related signal, and a query velocity that represents motion of a corresponding region of a three-dimensional scene across successive timesteps.

In some embodiments, query decoder module 320 may generate, for each refined query, parameters for multiple Gaussian primitives to represent local structure around the query. Query decoder module 320 may output per-Gaussian parameters for each Gaussian primitive derived from a query, including a per-Gaussian location offset, a per-Gaussian opacity factor, a Gaussian scale, and a Gaussian rotation. The number of Gaussian primitives decoded per query may be configurable and may vary across model configurations. Query decoder module 320 may implement one or more multilayer perceptrons, linear layers, or other parameter prediction heads that map the refined latent feature representation of a query to the query-level outputs and per-Gaussian outputs.

In some embodiments, query decoder module 320 may operate in different modes depending on a training stage. During a geometry-focused pretraining stage, query decoder module 320 may output attributes suitable for rendering supervision, including color attributes for Gaussian primitives, enabling rendered color images and rendered depth maps to be compared with corresponding observations. During a semantic occupancy prediction stage, query decoder module 320 may output semantic class information associated with Gaussian primitives. In some embodiments, semantic class information may be shared across Gaussian primitives derived from a same refined query, supporting consistent semantic labeling within a local region anchored by the refined query.

In some embodiments, query decoder module 320 may output additional attributes usable by downstream modules, such as a per-Gaussian class distribution, a background class probability, or parameters that support efficient Gaussian-to-voxel aggregation. Query decoder module 320 may also output intermediate signals usable for selecting queries for propagation, including the query opacity or another confidence measure. Query decoder module 320 may output decoded query-level parameters and per-Gaussian parameters to Gaussian parameter assembly module 322 for construction of complete Gaussian primitives.

By decoding a compact set of refined sparse three-dimensional queries into a structured set of Gaussian parameters that include query-level controls and per-Gaussian refinements, query decoder module 320 supports conversion from a sparse internal representation to a richer set of geometric primitives suitable for generating dense semantic scene representations.

Gaussian parameter assembly module 322 may be configured to assemble complete three-dimensional Gaussian primitives by combining query-level parameters and per-Gaussian parameters produced by a query decoder module (for example, query decoder module 320) with query anchor locations produced by upstream modules. In some embodiments, Gaussian parameter assembly module 322 may construct, for each refined query, a set of Gaussian primitives whose spatial attributes are hierarchically related to the refined query. For example, a Gaussian center location may be computed as a combination of a query anchor location, a query location offset, and a per-Gaussian location offset. This hierarchical location composition anchors a group of Gaussian primitives to a refined query while enabling each Gaussian primitive to represent local structure relative to the refined query.

In some embodiments, Gaussian parameter assembly module 322 may compute an opacity for each Gaussian primitive as a product of a query-level opacity and a per-Gaussian opacity factor. The query-level opacity may provide a coarse confidence signal that modulates visibility or contribution of Gaussian primitives derived from a refined query, and the per-Gaussian opacity factor may provide finer control over contribution of an individual Gaussian primitive. Such hierarchical opacity composition supports downstream selection of queries for propagation and supports opacity-weighted aggregation when generating voxel-aligned occupancy probabilities.

Gaussian parameter assembly module 322 may further assemble additional Gaussian primitive parameters, including Gaussian scale and Gaussian rotation. In some embodiments, Gaussian scale and Gaussian rotation may be used to derive a covariance representation for each Gaussian primitive, for example, by converting a quaternion rotation representation to a rotation matrix and combining the rotation matrix with scale factors. Gaussian parameter assembly module 322 may also associate a query velocity with each Gaussian primitive derived from a refined query, enabling downstream rendering of neighboring timesteps or motion-aware propagation of Gaussian attributes.

In some embodiments, Gaussian parameter assembly module 322 may assign semantic class information to Gaussian primitives. During a semantic occupancy prediction stage, semantic class information may be shared among Gaussian primitives derived from a same refined query, enabling consistent semantic labeling for a region anchored by the refined query. During a geometry-focused pretraining stage, Gaussian parameter assembly module 322 may instead associate per-Gaussian color attributes with Gaussian primitives for rendering supervision.

Gaussian parameter assembly module 322 may output assembled Gaussian primitives to a semantic representation construction module (for example, semantic representation construction module 324). By implementing hierarchical assembly of Gaussian center locations and Gaussian opacities from query-level and per-Gaussian parameters, Gaussian parameter assembly module 322 realizes a structured conversion from sparse queries to Gaussian primitives that can be efficiently aggregated into dense semantic representations.

Semantic representation construction module 324 may be configured to generate a dense three-dimensional semantic representation of a scene from assembled three-dimensional Gaussian primitives. In some embodiments, semantic representation construction module 324 may define a voxel grid that covers a region of interest in three-dimensional space and may compute, for voxel locations of the voxel grid, an occupancy probability and a semantic class distribution based on contributions of one or more Gaussian primitives that influence each voxel location. The voxel grid, voxel resolution, and region of interest may be configurable based on an intended application, and the semantic representation may be expressed in a voxel-aligned format suitable for downstream modules.

In some embodiments, semantic representation construction module 324 may determine, for a voxel location, which Gaussian primitives influence the voxel location based on spatial proximity between the voxel location and Gaussian centers and based on Gaussian scale and orientation. An occupancy probability for a voxel location may be computed using an aggregation of occupancy contributions from multiple Gaussian primitives. In some embodiments, an occupancy contribution of a Gaussian primitive may be weighted by an opacity value associated with the Gaussian primitive, enabling Gaussian primitives with higher opacity to contribute more strongly to occupancy probability.

In some embodiments, semantic representation construction module 324 may compute a semantic class distribution for a voxel location as a mixture or aggregation of class information associated with Gaussian primitives that influence the voxel location. The aggregation may weight contributions by spatial proximity and by opacity, and the aggregation may normalize contributions to produce a probability distribution over semantic classes for occupied regions and an empty or background class for unoccupied regions. Semantic representation construction module 324 may output occupancy and semantic predictions at voxel locations for a current timestep.

In some embodiments, semantic representation construction module 324 may implement an efficient Gaussian-to-voxel splatting operation. The voxel grid may be partitioned into voxel blocks, and for each voxel block, parameters of Gaussian primitives that influence voxel locations within the voxel block may be loaded into a memory region accessible for reuse when determining contributions for multiple voxel locations within the voxel block. Such block-based processing may improve reuse of Gaussian parameters across nearby voxel computations and may be implemented using parallel processing kernels.

Semantic representation construction module 324 may provide the voxel-based semantic representation to downstream processing modules, such as modules that consume occupancy and semantic predictions for analysis, planning, mapping, or other scene interpretation tasks. By converting a set of Gaussian primitives derived from a sparse query representation into voxel-aligned occupancy probabilities and semantic class distributions, semantic representation construction module 324 provides a dense output representation while preserving the sparse internal representation used by upstream streaming modules.

Query propagation module 326 may be configured to select, from a set of refined sparse three-dimensional queries for a current timestep, a subset of refined sparse three-dimensional queries for propagation to a temporal query queue for one or more future timesteps. In some embodiments, query propagation module 326 may select refined sparse three-dimensional queries based at least in part on a confidence measure associated with each refined query. The confidence measure may include a query opacity predicted by upstream modules, and the confidence measure may indicate a degree to which a refined query contributes to representing occupied or salient regions of a scene. Selection of the subset may include ranking refined queries by confidence, and selection of the subset may include selecting a predetermined number of refined queries or selecting refined queries that satisfy a confidence threshold.

In some embodiments, query propagation module 326 may enforce a diversity policy when selecting refined queries for propagation. The diversity policy may include enforcing a minimum spatial separation between selected refined queries, reducing overlap among propagated queries and supporting coverage across different spatial regions. Enforcing minimum spatial separation may include a greedy selection procedure that iteratively adds a candidate refined query to the subset when a distance between a candidate refined query location and locations of already selected refined queries exceeds a separation threshold. The separation threshold may be configurable and may be selected based on a spatial resolution of a scene representation.

In some embodiments, query propagation module 326 may update query locations of selected refined queries prior to insertion into the temporal query queue. The update may be based on predicted query velocities associated with the selected refined queries and a time interval between timesteps. Query velocity-based updates may translate query locations to account for motion of corresponding regions of the scene, enabling propagated queries to be spatially aligned for a subsequent timestep. In some embodiments, query propagation module 326 may combine velocity-based updates with observer-motion compensation applied elsewhere in the pipeline so that propagated queries remain consistent with a coordinate frame of a subsequent timestep.

In some embodiments, query propagation module 326 may output, alongside propagated queries, auxiliary metadata such as a timestep identifier, a confidence value, or a query age value. Query propagation module 326 may provide propagated queries to a query queue update module (for example, query queue update module 328) for insertion into the temporal query queue. Query propagation module 326 may be configured to operate in both training and inference contexts. During training, selection and propagation may support supervision across neighboring timesteps; during inference, selection and propagation may support continuity of a sparse internal representation across successive timesteps.

By selecting a subset of refined queries for propagation using confidence signals and optional diversity constraints, and by updating selected query locations using motion information, query propagation module 326 supports maintenance of a compact temporal memory of scene information for streaming semantic scene representation generation.

Query queue update module 328 may be configured to update a temporal query queue by inserting propagated sparse three-dimensional queries selected for a future timestep and by applying a queue management policy that maintains a bounded queue length. Query queue update module 328 may receive, from a query propagation module (for example, query propagation module 326), a subset of refined sparse three-dimensional queries designated for propagation and may append the propagated queries to the temporal query queue. In some embodiments, query queue update module 328 may manage the temporal query queue according to a first-in, first-out policy, and in other embodiments, query queue update module 328 may manage the temporal query queue according to another ordered retention policy. The retention policy may remove older query sets as newer query sets are inserted to maintain a bounded number of historical timesteps.

In some embodiments, query queue update module 328 may store, for each propagated query, associated metadata such as a timestep identifier, a coordinate frame identifier, a confidence value, or a query provenance indicator. The metadata may support subsequent retrieval and alignment operations performed by a query queue management module (for example, query queue management module 312) and may support selection operations performed by a query formation module (for example, query formation module 316). Query queue update module 328 may preserve query locations in coordinate frames associated with the timestep at which the propagated queries are generated, and observer-motion compensation may be applied when the propagated queries are retrieved for a later timestep. In other embodiments, query queue update module 328 may store query locations in a common coordinate frame, depending on a selected motion-compensation strategy.

In some embodiments, query queue update module 328 may apply filtering operations to propagated queries prior to insertion, for example by discarding propagated queries that fail a confidence threshold, discarding propagated queries outside a region of interest, or discarding propagated queries that violate a diversity policy. Such filtering may be configured as an optional preprocessing step that complements selection performed by a query propagation module (for example, query propagation module 326). Query queue update module 328 may also support persistence of the temporal query queue in electronic storage, enabling checkpointing of query state or transfer of query state between processing contexts.

Query queue update module 328 may provide diagnostic outputs associated with queue state, such as a current queue length, query age distribution, or spatial coverage statistics, to support configuration and monitoring. Query queue update module 328 may output an updated temporal query queue for access by a query queue management module (for example, query queue management module 312). By managing insertion and retention of propagated sparse three-dimensional queries, query queue update module 328 supports continuity of the temporal memory used by the streaming query-based scene representation pipeline.

Training orchestration module 330 may be configured to coordinate training of a perception system that generates semantic scene representations from sparse three-dimensional queries, including a geometry-focused training stage and a semantic occupancy training stage. Training orchestration module 330 may manage execution of forward passes through modules that initialize, refine, and decode sparse three-dimensional queries, and training orchestration module 330 may manage computation of training objectives and parameter updates based on the training objectives.

In some embodiments, during a geometry-focused stage, training orchestration module 330 may initialize sparse three-dimensional query locations using three-dimensional point data representing structure of a three-dimensional scene and may inject noise into the initialized query locations. The geometry-focused stage may train the system to align queries and decoded Gaussian primitives with scene geometry using a denoising objective. The denoising objective may supervise movement of query locations toward occupied regions by penalizing deviation between denoised query locations and target point locations. Training orchestration module 330 may further compute one or more rendering objectives by rendering depth maps and, in some embodiments, color images from Gaussian primitives decoded from refined queries and comparing the rendered outputs with corresponding observations. Rendering supervision may be applied at a present timestep and at one or more neighboring timesteps by propagating queries or Gaussian primitives using predicted query velocities and by accounting for observer motion when relating coordinate frames across timesteps.

In some embodiments, during a semantic occupancy stage, training orchestration module 330 may train the system to generate a voxel-aligned semantic representation derived from Gaussian primitives decoded from refined queries. The semantic occupancy stage may compute a semantic objective that supervises voxel occupancy probabilities and semantic class distributions produced by a semantic representation construction module (for example, semantic representation construction module 324). In some embodiments, semantic class information may be predicted at a query level and shared across Gaussian primitives derived from a same refined query. Training orchestration module 330 may schedule parameter updates such that parameter updates based on a geometry-focused objective occur before parameter updates based on a semantic objective, supporting a staged training paradigm.

Training orchestration module 330 may configure training hyperparameters such as batch size, learning rate, and training duration, and may support use of pretrained backbone weights for image feature extraction. Training orchestration module 330 may further manage checkpointing of model parameters between stages and may support evaluation of trained models using task-specific metrics. By coordinating staged objectives that train sparse queries to align with geometry and then to support semantic occupancy prediction, training orchestration module 330 supports training of the streaming sparse-query-based semantic scene representation pipeline disclosed herein.

In some implementations, computing platform(s) 302, remote platform(s) 304, and/or external resources 358 may be operatively linked via one or more electronic communication links. For example, such electronic communication links may be established, at least in part, via network 150 such as the Internet and/or other networks. It will be appreciated that this is not intended to be limiting, and that the scope of this disclosure includes implementations in which computing platform(s) 302, remote platform(s) 304, and/or external resources 358 may be operatively linked via some other communication media.

A given remote platform(s) 304 may include client computing devices, such as a first client device or second client device, which may each include one or more processors configured to execute computer program modules (for example, the instruction modules). The computer program modules may be configured to enable an expert or user associated with the given remote platform to interface with system 300 and/or external resources 358, and/or provide other functionality attributed herein to remote platform(s) 304. By way of non-limiting example, given remote platform(s) 304 and/or given computing platform(s) 302 may include one or more of a server, a desktop computer, a laptop computer, a handheld computer, a tablet computing platform, a NetBook, a smartphone, a gaming console, an automated vehicle, and/or other computing platforms. External resources 358 may include sources of information outside of system 300, external entities participating with the system 300, and/or other resources.

Computing platform(s) 302 may include electronic storage 352, one or more processor(s) 360, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 352 may comprise non-transitory storage media that electronically stores information. Electronic storage media of electronic storage 352 may include one or both of system storage that is provided integrally (that is, substantially non-removable) with computing platform(s) 302 and/or removable storage that is removably connectable to computing platform(s) 302 via, for example, a port (for example, a USB port, a firewire port, etc.) or a drive (for example, a disk drive, etc.). Electronic storage 352 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 352 may include one or more virtual storage resources (for example, cloud storage, a virtual private network, and/or other virtual storage resources). Electronic storage 352 may store software algorithms, information determined by processor(s) 360, information received from computing platform(s) 302, information received from remote platform(s) 304, and/or other information that enables computing platform(s) 302 to function as described herein.

Processor(s) 360 may be configured to provide information processing capabilities in computing platform(s) 302. As such, processor(s) 360 may include one or more of a digital processor, an analog processor, a digital circuit designed to process information, an analog circuit designed to process information, a state machine, and/or other mechanisms for electronically processing information. Although processor(s) 360 is shown in FIG. 3 as a single entity, this is for illustrative purposes only. In some implementations, processor(s) 360 may include a plurality of processing units. These processing units may be physically located within the same device, or processor(s) 360 may represent processing functionality of a plurality of devices operating in coordination. Processor(s) 360 may be configured to execute modules 308, 310, 312, 314, 316, 318, 320, 322, 324, 326, 328, and/or 330, and/or other modules. Processor(s) 360 may be configured to execute modules 308, 310, 312, 314, 316, 318, 320, 322, 324, 326, 328, and/or 330, and/or other modules by software; hardware; firmware; some combination of software, hardware, and/or firmware; and/or other mechanisms for configuring processing capabilities on processor(s) 360. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, 324, 326, 328, and/or 330 are illustrated in FIG. 3 as being implemented within a single processing unit, in implementations in which processor(s) 360 includes multiple processing units, one or more of modules 308, 310, 312, 314, 316, 318, 320, 322, 324, 326, 328, and/or 330 may be implemented remotely from the other modules. The description of the functionality provided by the different modules 308, 310, 312, 314, 316, 318, 320, 322, 324, 326, 328, and/or 330 described below is for illustrative purposes, and is not intended to be limiting, as any of modules 308, 310, 312, 314, 316, 318, 320, 322, 324, 326, 328, and/or 330 may provide more or less functionality than is described. For example, one or more of modules 308, 310, 312, 314, 316, 318, 320, 322, 324, 326, 328, and/or 330 may be eliminated, and some or all of its functionality may be provided by other ones of modules 308, 310, 312, 314, 316, 318, 320, 322, 324, 326, 328, and/or 330. As another example, processor(s) 360 may be configured to execute one or more additional modules that may perform some or all of the functionality attributed below to one of modules 308, 310, 312, 314, 316, 318, 320, 322, 324, 326, 328, and/or 330.

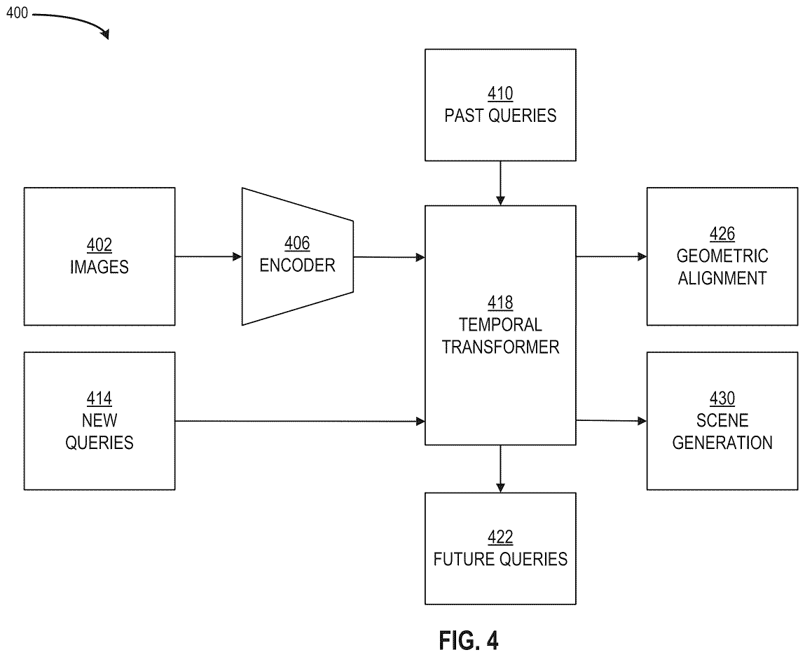

FIG. 4 is a block diagram illustrating an example streaming perception architecture 400 for refining sparse three-dimensional (3D) queries using image features and temporal information to produce scene outputs and propagated queries, according to certain aspects of the present disclosure. Architecture 400 may support real-time or near-real-time perception and prediction for multiple application domains, including, for example, transportation, robotics, augmented reality, virtual reality, industrial inspection, warehouse automation, aerial mapping, security monitoring, sports analytics, and mobile-device spatial understanding.

In some embodiments, architecture 400 may operate on multi-view images, single-view images, monocular video, stereo images, or a combination thereof. Images 402 may include a set of camera frames captured at timestep t from one or more sensors. For example, images 402 may include RGB images captured from a head-mounted camera used in augmented reality, images captured from a fixed camera array used for industrial inspection, or images captured from a handheld device used for room scanning. Images 402 may be associated with calibration parameters, timestamps, and sensor pose metadata. If sensor pose metadata may be unavailable, then architecture 400 may infer observer motion from visual cues and temporal correspondences.

Encoder 406 may receive images 402 and may generate feature representations usable by subsequent attention operations. In some embodiments, encoder 406 may include a convolutional neural network, a vision transformer, or a hybrid backbone. Encoder 406 may output a feature tensor for each image viewpoint, for example, a set of multi-scale feature maps with spatial resolution and channel depth selected to balance accuracy and compute. Encoder 406 may additionally output positional encodings, camera-ray encodings, or depth priors derived from stereo disparity or monocular depth estimation.

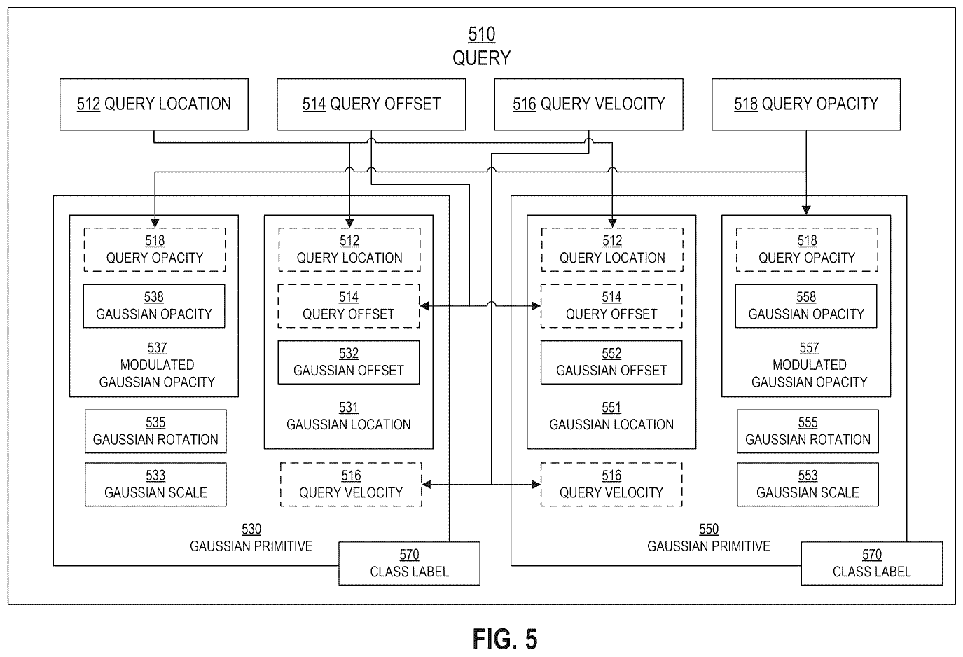

Temporal transformer 418 may receive at least three inputs: encoded image features from encoder 406; past queries 410; and new queries 414. Past queries 410 may include a queue of queries previously generated for one or more prior timesteps. New queries 414 may include query seeds for timestep t that may be randomly initialized, learned, sampled from a 3D region of interest, derived from keypoints, or derived from external signals. For example, new queries 414 may be sampled on a 3D grid spanning a factory floor, a warehouse aisle, or an indoor room volume. In some embodiments, new queries 414 may include query attributes such as query location, query offset, query velocity, query opacity, and query feature embeddings, with specific attribute definitions illustrated in FIG. 5.

Temporal transformer 418 may refine query features and query parameters via self-attention among queries and cross-attention from queries to encoded image features. In some embodiments, temporal transformer 418 may fuse temporal information by attending to past queries 410, enabling query persistence and long-horizon context without reliance on dense voxel memory. If past queries 410 include stale or low-confidence entries, then temporal transformer 418 may downweight contributions by opacity or confidence values. In some embodiments, temporal transformer 418 may generate an updated set of current queries representing scene structure at timestep t, and temporal transformer 418 may additionally generate future queries 422 representing a propagated subset for timestep t+1.

Query propagation may incorporate motion modeling. In some embodiments, temporal transformer 418 may predict a per-query velocity vector that may represent apparent object motion in a world coordinate frame, as well as compensation for observer motion between timesteps. For example, a query associated with a moving forklift in a warehouse may include a forward velocity estimate, while a query associated with a wall surface may include near-zero velocity. Observer motion may be modeled separately and applied as a transform to query locations, or observer motion may be implicitly absorbed into query velocity predictions by training objectives.

In some embodiments, architecture 400 may use a hierarchical decoding from queries to Gaussian primitives, consistent with Equations [1] through [4] disclosed herein. In particular, Equation [1] describes a hierarchical mapping in which each sparse query generates multiple parametric primitives by combining query-level position, motion, and opacity with primitive-level geometric refinements to represent detailed scene structure over time. Equation [2] describes an opacity-weighted occupancy probability for stabilizing foreground-background separation. Equation [3] describes an example initialization for query locations using furthest-point sampling and noise. Equation [4] describes an example multi-term loss including denoising and rendering supervision.

For example, a query indexed by i may decode into a bundle of J Gaussians indexed by j, wherein a Gaussian position may be defined by a base query position plus a predicted query offset plus a Gaussian-specific offset, and wherein an opacity for each Gaussian primitive may be modulated by a query-level opacity multiplied by a Gaussian-level opacity. Equation [1] expresses an example Gaussian set for timestep t as:

$${𝒢}_{t} = {\{ {\{ ( {p}^{i} + {o}^{i} + {o}_{j}^{i} , {v}^{i} , {r}_{j}^{i} , {s}_{j}^{i} , {a}^{i} \cdot {a}_{j}^{i} ) \}}_{j = 1}^{J} \}}_{i = 1}^{K} \qquad [ 1 ]$$

Accordingly, Equation [1] defines a set [symbol] ₜ of parametric primitives at a timestep t, wherein the set is organized hierarchically by queries and by primitives derived from each query. Index i∈{1, . . . , K} denotes a query, and index j∈{1, . . . , J} denotes a primitive associated with a given query, wherein K represents a number of queries at timestep t and J represents a number of primitives generated per query. For each query i, a base three-dimensional query location pⁱ∈ [symbol] ³ defines an anchor position in a scene coordinate frame, and a query offset oⁱ∈ [symbol] ³ refines that anchor to better align with observed structure. A query velocity vⁱ∈ [symbol] ³ represents estimated motion of a region associated with the query across timesteps, supporting temporal propagation. A query-level opacity aⁱ∈ [symbol] represents a confidence or strength associated with the query contribution.

For each query i, a set of J primitives is defined, wherein each primitive j includes a primitive-specific offset

$${o}_{j}^{i} ∈ {ℝ}^{3}$$

that captures local geometric variation around the refined query location, a rotation parameter

$${r}_{j}^{i} ∈ {ℝ}^{4}$$

that defines an orientation of the primitive, and a scale parameter

$${s}_{j}^{i} ∈ {ℝ}^{3}$$

that defines an anisotropic spatial extent. Each primitive further includes a primitive-level opacity

$${a}_{j}^{i} ∈ ℝ .$$

The three-dimensional position of primitive j derived from query i is given by the sum

$${p}^{i} + {o}^{i} + {o}_{j}^{i} ,$$

combining the base query location, the query-level refinement, and the primitive-level refinement. The effective opacity of primitive j derived from query i is given by the product

$${a}^{i} \cdot {a}_{j}^{i} ,$$

which modulates the primitive-level opacity by the query-level opacity. Collectively, Equation [1] describes a hierarchical representation in which each query anchors a spatial region and each associated primitive represents finer-grained geometric, motion, and confidence information within that region.

Geometric alignment 426 may receive outputs from temporal transformer 418, including refined query locations, velocities, and decoded Gaussian parameters. Geometric alignment 426 may generate alignment data for mapping, localization, registration, or coordinate-frame reconciliation. For example, geometric alignment 426 may align a reconstructed scene representation to a building information model, a floorplan, a previously built map, or a digital twin. If a robotics platform navigates through a warehouse, then geometric alignment 426 may align current spatial estimates to a warehouse map to support path planning and collision avoidance.

Scene generation 430 may receive outputs from temporal transformer 418 and may generate a representation of a scene at timestep t and optionally at future timesteps. In some embodiments, scene generation 430 may output occupancy, semantic occupancy, instance segmentation, depth, surface normals, or a 3D Gaussian splatting representation. For example, scene generation 430 may render a predicted depth map for augmented reality occlusion handling, or scene generation 430 may generate a semantic occupancy field indicating free space versus occupied space for a robot manipulator.

In some embodiments, architecture 400 may support training objectives that encourage query movement toward occupied structure and discourage collapse to degenerate configurations. For example, a denoising objective may encourage query locations to match sampled 3D points, and rendering losses may supervise predicted Gaussians to match depth and appearance observations at current and neighboring timesteps.

FIG. 5 is a schematic diagram illustrating example query structure 510 and a derivation of multiple Gaussian primitives from query structure 510, according to certain aspects of the present disclosure. As shown in FIG. 5, query attributes of example query structure 510 may map to Gaussian primitive 530 and Gaussian primitive 550. Query structure 510 may represent a compact, persistent scene state that may be refined over time and decoded into a denser set of geometric primitives for downstream perception tasks. In some embodiments, query structure 510 may include query location 512, query offset 514, query velocity 516, and query opacity 518. Query structure 510 may additionally include a latent feature vector used by attention modules and decoders, although FIG. 5 emphasizes geometric and rendering-related parameters.

Query location 512 may represent a base 3D position for a query, for example, a point in a world coordinate frame. Query offset 514 may represent a learned displacement applied to query location 512 during refinement. Query velocity 516 may represent a temporal motion estimate for a query, supporting streaming propagation. Query opacity 518 may represent a confidence or density proxy indicating whether a query corresponds to occupied structure, dynamic objects, or background. In some embodiments, query opacity 518 may operate as a gating parameter that may modulate contributions from query structure 510 to a decoded Gaussian set and to training losses.

Gaussian primitive 530 may be derived from a subset of query attributes and may include Gaussian location 531, Gaussian offset 532, Gaussian scale 533, Gaussian rotation 535, and modulated Gaussian opacity 537. Gaussian opacity 538 may be a Gaussian-level opacity predicted for a specific Gaussian within a bundle, and modulated Gaussian opacity 537 may result from combining Gaussian opacity 538 with query opacity 518. In some embodiments, modulated Gaussian opacity 537 may equal a product of a query-level opacity and a Gaussian-level opacity, enabling a query to control overall strength while enabling each Gaussian primitive to capture local variation.

Gaussian primitive 550 may similarly be derived and may include Gaussian location 551, Gaussian offset 552, Gaussian scale 553, Gaussian rotation 555, and modulated Gaussian opacity 557 derived from Gaussian opacity 558 and query opacity 518. FIG. 5 depicts multiple Gaussian primitives to indicate that a single query may decode into multiple Gaussians, enabling representation of local surface shape and volumetric extent while retaining a sparse query count.

In some embodiments, query structure 510 may decode into a set of Gaussians according to Equation [1]. A query index i may decode into Gaussians indexed by j, with Gaussian position expressed as a sum of base query position pⁱ, query offset oⁱ, and Gaussian-specific offset

$${o}_{j}^{i} .$$

A velocity vⁱ may be shared among Gaussians derived from a common query, supporting coherent motion for dynamic regions. A rotation

$${r}_{j}^{i}$$

and scale

$${s}_{j}^{i}$$

may be Gaussian-specific, supporting anisotropic ellipsoids aligned to local surface orientation. An opacity term

$${a}^{i} \cdot {a}_{j}^{i}$$

may implement modulation of Gaussian-level opacity by query-level opacity.

In some embodiments, Gaussian location 531 and Gaussian location 551 may correspond to

$${p}^{i} + {o}^{i} + {o}_{j}^{i} .$$

Query location 512 may correspond to pⁱ. Query offset 514 may correspond to oⁱ. Gaussian offset 532 and Gaussian offset 552 may correspond to

$${o}_{j}^{i} .$$

Query velocity 516 may correspond to vⁱ. Gaussian rotation 535 and Gaussian rotation 555 may correspond to

$${r}_{j}^{i} .$$

Gaussian scale 533 and Gaussian scale 553 may correspond to

$${s}_{j}^{i} .$$

Query opacity 518 may correspond to aⁱ. Gaussian opacity 538 and Gaussian opacity 558 may correspond to

$${a}_{j}^{i} .$$

Modulated Gaussian opacity 537 and modulated Gaussian opacity 557 may correspond to

$${a}^{i} \cdot {a}_{j}^{i} .$$

Class label 570 may represent a semantic category associated with a query and shared across multiple Gaussians derived from query structure 510. In some embodiments, class label 570 may be predicted as a distribution over classes and may be used to generate semantic occupancy outputs, instance segmentation outputs, or material classification outputs. For example, in an industrial inspection setting, class label 570 may include categories such as crack, corrosion, fastener, cable, or background. In an augmented reality setting, class label 570 may include categories such as floor, wall, ceiling, furniture, or person.

In some embodiments, query opacity 518 may serve as a confidence score for whether a query should persist across timesteps. For example, a query associated with a moving pedestrian in a security video may have high query opacity 518 and nonzero query velocity 516, while a query associated with transient sensor noise may have low query opacity 518 and may be dropped during propagation. If query opacity 518 falls below a threshold, then a scheduler may omit a query from a future queue, reducing compute while maintaining accuracy.

In some embodiments, an occupancy probability for a voxel location x may incorporate opacity-weighted occupancy contributions from Gaussians. Equation [2] provides an example formulation that multiplies opacity a with an exponential term based on a Gaussian covariance X and offset (x−m), yielding:

$$α ( x ; 𝒢 ) = a exp ( - \frac{1}{2} {( x - m )}^{T} {\sum }^{- 1} ( x - m ) ) \qquad [ 2 ]$$

Accordingly, Equation [2] defines an opacity-weighted occupancy probability α(x; [symbol] ) at a spatial location x∈ [symbol] ³, wherein α(x; [symbol] )∈ [symbol] represents a likelihood that the location is occupied by a parametric primitive from a set of primitives [symbol] . The term a∈ [symbol] denotes an opacity value associated with a primitive, wherein the opacity acts as a confidence or density weighting factor that scales the contribution of the primitive to occupancy. The vector m∈ [symbol] ³ denotes a three-dimensional mean or center location of the primitive. The matrix Σ∈ [symbol] ^{3×3} denotes a covariance matrix defining the spatial extent, orientation, and anisotropy of the primitive, and Σ⁻¹ denotes the inverse of the covariance matrix. The quadratic form (x−m)^{T}Σ⁻¹(x−m) measures a Mahalanobis distance between the spatial location and the primitive center, and the exponential term exp

$$( - \frac{1}{2} {( x - m )}^{T} {\sum }^{- 1} ( x - m ) )$$

defines a Gaussian-shaped decay of occupancy likelihood with distance from the primitive center. The opacity-weighted formulation may encourage background Gaussians to reduce opacity rather than collapsing scale, and this formulation may improve separation between occupied and unoccupied regions.

In some embodiments, query structure 510 may support observer motion compensation by applying a rigid transform to query location 512 between timesteps. For example, a head-mounted camera wearer may rotate and translate through an indoor environment, and query velocity 516 may model object motion while a separate transform may model observer motion. If observer motion estimation is uncertain, then modulated Gaussian opacity 537 and modulated Gaussian opacity 557 may downweight unreliable Gaussians during fusion.

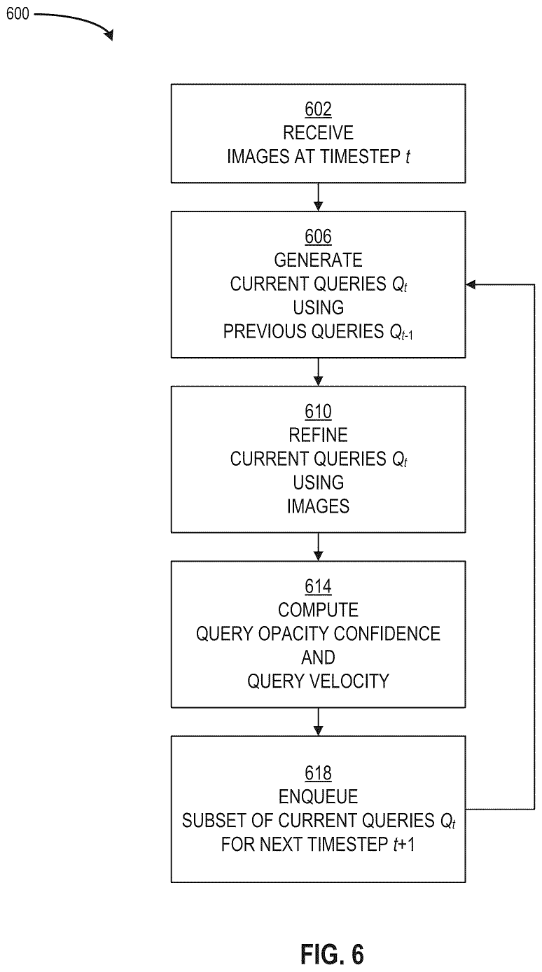

FIG. 6 illustrates example process 600 for streaming query generation and refinement over discrete timesteps, according to certain aspects of the present disclosure. Process 600 may be executed by one or more processors and may be implemented using a neural network pipeline including, for example, encoder 406 and temporal transformer 418 of FIG. 4, and query structure 510 of FIG. 5. Process 600 may support online operation in which a scene representation may be maintained as a compact set of persistent queries and updated as new images arrive.

At operation 602, images may be received at timestep t. Images may include one or more frames from one or more cameras. For example, operation 602 may receive synchronized frames from a camera array on a robot, a wearable camera, a drone camera, or a stationary surveillance system. Images may include metadata such as timestamps and intrinsics. In some embodiments, operation 602 may receive inertial measurements, wheel odometry, or other signals that may assist observer motion estimation, although process 600 may operate using images alone.

At operation 606, current queries Qₜ may be generated using previous queries Qₜ₋₁. Operation 606 may implement temporal propagation to form an initial hypothesis for timestep t prior to incorporating new image evidence. In some embodiments, operation 606 may apply observer motion compensation to query locations. For example, if a camera moves forward, then query locations may be transformed to remain approximately aligned in a global frame. Operation 606 may additionally apply per-query velocity to predict motion of dynamic regions. For example, a query corresponding to a moving conveyor belt load may shift according to query velocity, while a query corresponding to a stationary wall may shift primarily due to observer motion.

In some embodiments, operation 606 may generate new query candidates in addition to propagated queries. For example, operation 606 may sample new queries in regions with low coverage, such as newly observed portions of a warehouse aisle. If a coverage metric indicates sparse query density in a region, then operation 606 may insert additional queries with low initial opacity and allow refinement to raise opacity for occupied regions.

At operation 610, current queries Qₜ may be refined using images. Operation 610 may include cross-attention from queries to image features, enabling updates to query location (for example, query location 512), query offset (for example, query offset 514), query velocity (for example, query velocity 516), query opacity (for example, query opacity 518), and latent embeddings. In some embodiments, operation 610 may implement a hierarchical decode from queries to Gaussian primitives, allowing local structure updates driven by image evidence. For example, a query near an object boundary in an augmented reality scene may refine Gaussian offsets to better fit a curved chair back, and a query near a planar wall may refine Gaussian rotation and scale to represent a large planar patch.

In some embodiments, operation 610 may be trained using a denoising and rendering supervision stage. Equation [3] describes an example initialization of query locations using furthest-point sampling on a point set and additive uniform noise:

$${\{ {p}_{i} \}}_{i = 0}^{K} = {FPS}_{K} ( pts ) + ϵ \qquad [ 3 ]$$

Accordingly, Equation [3] defines an initialization of query locations for a given timestep using a set of three-dimensional points. In Equation [3],

$${\{ {p}_{i} \}}_{i = 0}^{K}$$

denotes a set of K query locations, wherein each pᵢ∈ [symbol] ³ represents a three-dimensional position assigned to a query. The term FPS_{K}(pts) denotes a furthest-point-sampling operation applied to a set of three-dimensional points pts∈ [symbol] ^{M×3} available at timestep t, wherein M represents a number of input points and the sampling operation selects K points that are spatially well distributed. The term ϵ∈ [symbol] ^{K×3} denotes additive noise applied to the sampled query locations, wherein each noise component is independently drawn from a uniform distribution U(−e, e). The scalar e∈ [symbol] denotes a noise magnitude parameter that controls the range of the uniform distribution. Collectively, Equation [3] defines query locations as spatially distributed samples perturbed by bounded random noise to encourage robust refinement during subsequent processing. This initialization may encourage even spatial coverage and may improve convergence. Starting at noised positions, query offsets

$${\{ {o}_{t}^{i} \}}_{i = 1}^{K}$$

and derived Gaussians [symbol] may be determined.

At operation 614, query opacity confidence and query velocity may be computed. Operation 614 may include producing a scalar opacity value representing occupancy confidence and a vector velocity representing predicted motion. In some embodiments, opacity may modulate occupancy estimation as in Equation [2], wherein opacity multiplies an exponential Gaussian occupancy term. For example, a query associated with empty space in a corridor may produce low opacity, reducing contribution to occupancy. A query associated with a moving person may produce high opacity and a nonzero velocity, enabling temporal consistency.

Operation 614 may also incorporate a multi-term objective as in Equation [4], which includes a denoising term and rendering terms:

$$ℒ = {λ}_{1} {\sum }_{i = 1}^{K} ‖ {FPS}_{K} ( {pts}_{t} ) - ( {p}_{t}^{i} + {o}_{t}^{i} ) ‖ + {λ}_{2} {ℒ}_{d e p t h} ( 𝒢 , D ) + {λ}_{3} {ℒ}_{rgb} ( 𝒢 , I ) \qquad [ 4 ]$$

Accordingly Equation [4] defines a training loss [symbol] used to supervise query refinement and primitive generation, wherein [symbol] ∈ [symbol] represents a scalar objective minimized during training. The scalars λ₁, λ₂, and λ₃∈ [symbol] denote weighting coefficients that balance contributions of different loss terms. Index i∈{1, . . . , K} denotes a query, and K denotes a number of queries. The term FPS_{K}(ptsₜ) denotes a set of K three-dimensional reference points obtained by applying furthest-point sampling to a point set ptsₜ∈ [symbol] ^{M×3} at timestep t, wherein M denotes a number of available points. The term

$${p}_{t}^{i} ∈ {ℝ}^{3}$$

denotes a base location of query i at timestep t, and the term

$${o}_{t}^{i} ∈ {ℝ}^{3}$$

denotes a predicted query offset, such that

$${p}_{t}^{i} + {o}_{t}^{i}$$

represents a refined query location. The first term of the loss measures a denoising error between sampled reference points and refined query locations using a vector norm. The term [symbol] _{depth}( [symbol] ,Dₜ) denotes a depth rendering loss computed by rendering a set of parametric primitives [symbol] into one or more depth maps and comparing the rendered depth to reference depth data Dr. The term [symbol] _{rgb}( [symbol] ,Iₜ) denotes an appearance rendering loss computed by rendering primitives [symbol] into one or more images and comparing the rendered images to observed image data Iₜ. Collectively, Equation [4] defines a multi-term objective that jointly encourages spatial alignment of queries, accurate geometric reconstruction, and visual consistency.

Rendering losses may supervise predicted Gaussians against depth maps and color images. Rendering supervision may use neighboring keyframes and may account for observer motion by moving Gaussians with predicted velocities and applying observer motion transforms.

At operation 618, a subset of current queries Qₜ may be enqueued for a next timestep t+1. Operation 618 may implement a memory management policy that selects queries to persist.

In some embodiments, operation 618 may select queries based on query opacity 518, class label stability, spatial coverage, and computational budget. If query opacity 518 fails to satisfy a threshold, then operation 618 may omit a query from an enqueued set, reducing drift and compute. If multiple queries overlap in 3D space and share a class label, then operation 618 may merge or suppress redundant queries and may retain a representative query with higher opacity confidence.

Process 600 may repeat for subsequent timesteps, producing a streaming scene representation. In some embodiments, downstream modules may consume queries and decoded Gaussians for tasks beyond occupancy, including object tracking, collision prediction, manipulation planning, view synthesis, and real-time rendering for augmented reality occlusion. For example, a warehouse robot may use query-based occupancy to plan a path around moving carts, while a mobile-device application may use query-based Gaussians to render a stable 3D reconstruction for interior design.

If a deployment environment includes limited compute, then process 600 may adjust a query count K, a Gaussian-per-query count J, or an enqueue fraction at operation 618, enabling scaling from embedded devices to server-class hardware while maintaining a consistent interface for geometric alignment and scene generation.

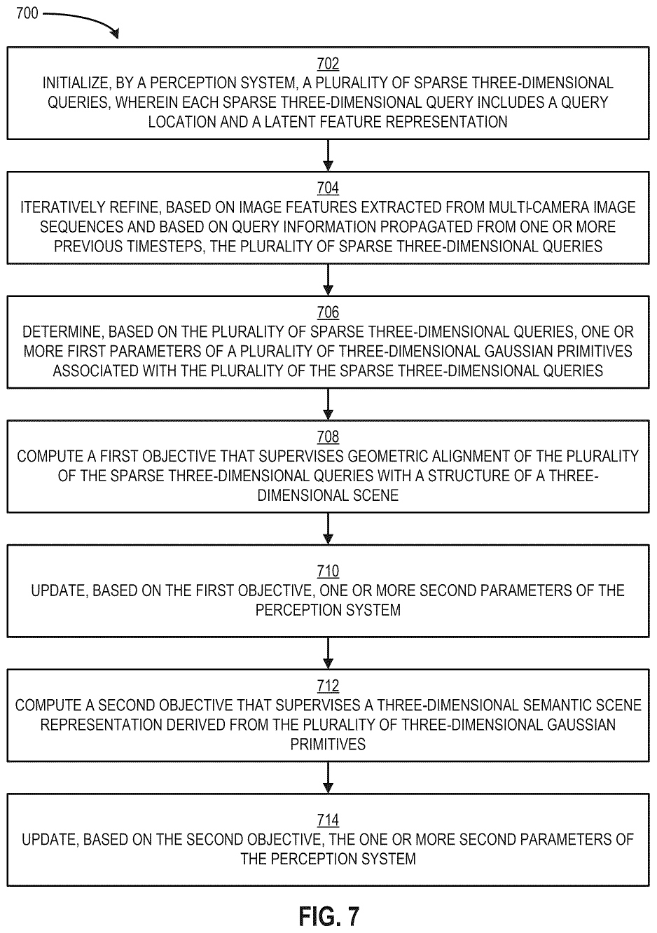

FIG. 7 illustrates an exemplary workflow for process 700 for training a vision-based three-dimensional perception system using sparse three-dimensional queries, according to certain aspects of the present disclosure.

At operation 702, process 700 may include initializing, by a perception system, a plurality of sparse three-dimensional queries. Each sparse three-dimensional query may include a query location and a latent feature representation. In some embodiments, initializing the plurality of sparse three-dimensional queries may include initializing the plurality of sparse three-dimensional queries using three-dimensional point data representing the structure of the three-dimensional scene. In some aspects of the embodiments, the three-dimensional point data representing the structure of the three-dimensional scene may include light detection and ranging (LiDAR) data. In some further aspects of the embodiments, the query location may be initialized with noised LiDAR data.

At operation 704, process 700 may include iteratively refining, based on image features extracted from multi-camera image sequences and based on query information propagated from one or more previous timesteps, the plurality of sparse three-dimensional queries. In some embodiments, process 700 may further include determining, for each sparse three-dimensional query of the plurality of sparse three-dimensional queries, a query velocity representing a motion of a corresponding region of the three-dimensional scene. In some aspects of the embodiments, process 700 may further include propagating, based on one or more query velocities, the plurality of sparse three-dimensional queries to one or more neighboring timesteps. In some aspects of the embodiments, process 700 may further include generating, based on the propagating of the sparse three-dimensional queries at the one or more neighboring timesteps, one or more rendered representations of the three-dimensional scene. In some aspects of the embodiments, process 700 may further include computing, based on a comparison between the one or more rendered representations and corresponding observations associated with the one or more neighboring timesteps, at least the first objective. In some embodiments, process 700 may further include selecting a subset of the sparse three-dimensional queries for propagation to a subsequent timestep based at least in part on a confidence measure determined for the subset of the sparse three-dimensional queries. In some aspects of the embodiments, the confidence measure used to select the subset of the sparse three-dimensional queries may include a query opacity determined for each sparse three-dimensional query of the plurality of sparse three-dimensional queries.

At operation 706, process 700 may include determining, based on the plurality of sparse three-dimensional queries, one or more first parameters of a plurality of three-dimensional Gaussian primitives associated with the plurality of the sparse three-dimensional queries. In some embodiments, determining the one or more first parameters of the plurality of three-dimensional Gaussian primitives may include determining multiple Gaussian primitives from each sparse three-dimensional query. In some embodiments, each three-dimensional Gaussian primitive may include at least a location, a scale, a rotation, and an opacity.

At operation 708, process 700 may include computing a first objective that supervises geometric alignment of the plurality of the sparse three-dimensional queries with a structure of a three-dimensional scene. In some embodiments, the first objective may supervise movement of the plurality of sparse three-dimensional queries from empty regions of the three-dimensional scene toward occupied regions of the three-dimensional scene. In some embodiments, process 700 may further include rendering one or more depth maps from the plurality of three-dimensional Gaussian primitives. In some embodiments, the first objective may be computed based on a comparison between the one or more rendered depth maps and one or more depth observations. In some embodiments, process 700 may further include rendering one or more color images from the plurality of three-dimensional Gaussian primitives. In some aspects of the embodiments, the first objective may be computed based on a comparison between the one or more rendered color images and one or more image observations.

At operation 710, process 700 may include updating, based on the first objective, one or more second parameters of the perception system.

At operation 712, process 700 may include computing a second objective that supervises a three-dimensional semantic scene representation derived from the plurality of three-dimensional Gaussian primitives. In some embodiments, each three-dimensional Gaussian primitive may include a semantic class label associated with a region of the three-dimensional scene. In some embodiments, a first three-dimensional Gaussian primitive and a second three-dimensional Gaussian primitive derived from a same sparse three-dimensional query may have a common semantic class label.

At operation 714, process 700 may include updating, based on the second objective, the one or more second parameters of the perception system. In some embodiments, updating based on the second objective may be performed after updating based on the first objective.

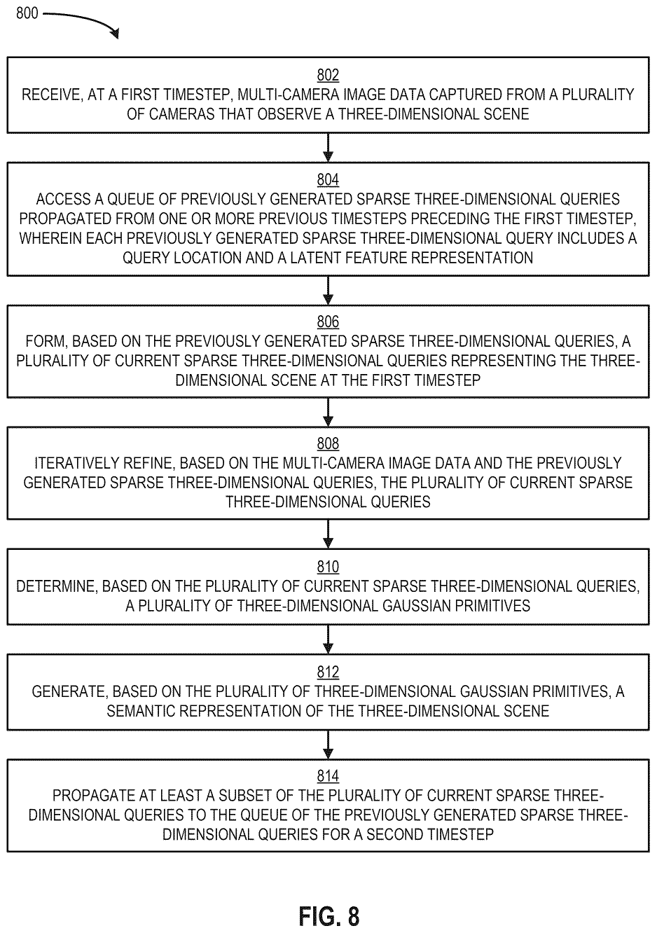

FIG. 8 illustrates an exemplary workflow for process 800 for generating semantic scene representations using sparse three-dimensional queries, according to certain aspects of the present disclosure.

At operation 802, process 800 may include receiving, at a first timestep, multi-camera image data captured from a plurality of cameras that observe a three-dimensional scene.

At operation 804, process 800 may include accessing a queue of previously generated sparse three-dimensional queries propagated from one or more previous timesteps preceding the first timestep. Each previously generated sparse three-dimensional query may include a query location and a latent feature representation.

At operation 806, process 800 may include forming, based on the previously generated sparse three-dimensional queries, a plurality of current sparse three-dimensional queries representing the three-dimensional scene at the first timestep. In some embodiments, process 800 may further include compensating for an observer motion by transforming one or more query locations of the previously generated sparse three-dimensional queries from respective coordinate frames associated with timesteps of the previously generated sparse three-dimensional queries into a coordinate frame associated with the first timestep. In some embodiments, forming the plurality of current sparse three-dimensional queries may include combining the previously generated sparse three-dimensional queries with one or more newly initialized sparse three-dimensional queries for the first timestep. In some aspects of the embodiments, the one or more newly initialized sparse three-dimensional queries may be initialized at learnable or predefined query locations within a region of interest of the three-dimensional scene.

At operation 808, process 800 may include iteratively refining, based on the multi-camera image data and the previously generated sparse three-dimensional queries, the plurality of current sparse three-dimensional queries.

At operation 810, process 800 may include determining, based on the plurality of current sparse three-dimensional queries, a plurality of three-dimensional Gaussian primitives. In some embodiments, determining the plurality of three-dimensional Gaussian primitives may include deriving, for each current sparse three-dimensional query, a query location offset, a query opacity, and multiple three-dimensional Gaussian primitives. In some aspects of the embodiments, determining the multiple three-dimensional Gaussian primitives may include computing, for each of the multiple three-dimensional Gaussian primitives, (i) a Gaussian location including a sum of the query location, the query location offset, and a per-Gaussian location offset, and (ii) a Gaussian opacity including a product of the query opacity and a per-Gaussian opacity factor. In some embodiments, each three-dimensional Gaussian primitive may include semantic class information associated with a region of the three-dimensional scene. In some embodiments, a first three-dimensional Gaussian primitive and a second three-dimensional Gaussian primitive derived from a same sparse three-dimensional query may have a common semantic class label.

At operation 812, process 800 may include generating, based on the plurality of three-dimensional Gaussian primitives, a semantic representation of the three-dimensional scene. In some embodiments, generating the semantic representation of the three-dimensional scene may include generating a three-dimensional voxel-based semantic representation by splatting the plurality of three-dimensional Gaussian primitives to a voxel grid, wherein the voxel grid includes a plurality of voxel locations. In some aspects of the embodiments, generating the semantic representation of the three-dimensional scene may further include computing, for each voxel location, (i) an occupancy probability, and (ii) a semantic class distribution based on contributions of one or more three-dimensional Gaussian primitives of the plurality of three-dimensional Gaussian primitives that influence the voxel location. In some aspects of the embodiments, computing the occupancy probability for each voxel location may include weighting an occupancy contribution of at least one of the three-dimensional Gaussian primitives by an opacity value associated with the at least one of the three-dimensional Gaussian primitives. In some embodiments, splatting the plurality of three-dimensional Gaussian primitives to the voxel grid may include partitioning the voxel grid into a plurality of voxel blocks, and loading, for each voxel block, parameters of one or more three-dimensional Gaussian primitives that influence voxel locations within the voxel block into a memory accessible for reuse when determining contributions for multiple voxel locations in the voxel block.

At operation 814, process 800 may include propagating at least a subset of the plurality of current sparse three-dimensional queries to the queue of the previously generated sparse three-dimensional queries for a second timestep. In some embodiments, propagating at least the subset of the plurality of current sparse three-dimensional queries may include selecting, based at least in part on one or more query opacities of the plurality of current sparse three-dimensional queries, the subset of the plurality of current sparse three-dimensional queries. In some aspects of the embodiments, selecting the subset may include enforcing a minimum spatial separation between the subset of the plurality of current sparse three-dimensional queries selected for propagation. In some embodiments, process 800 may further include determining, for each current sparse three-dimensional query, a query velocity representing motion of a corresponding region of the three-dimensional scene across successive timesteps. In some aspects of the embodiments, propagating at least the subset of the plurality of current sparse three-dimensional queries may include updating, based at least in part on one or more query velocities of the subset of the plurality of current sparse three-dimensional queries, one or more three-dimensional query locations of the subset of the plurality of current sparse three-dimensional queries to generate propagated sparse three-dimensional queries for the second timestep.

The techniques described herein may be implemented as method(s) (for example, processes 600, 700 and 800) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIGS. 6, 7, and 8 may be performed by a processor circuit executing instructions stored in a memory circuit, in a client device, a remote server, or a database, communicatively coupled through a network (for example, processors 212, memories 220, client device(s) 110, server(s) 130, database(s) 152, and network 150). In some embodiments, one or more of the steps in processes 600, 700 and 800 may be performed by one or more of modules 308, 310, 312, 314, 316, 318, 320, 322, 324, 326, 328 and/or 330 (as described in FIG. 3).

Although FIGS. 6, 7, and 8 show example blocks of processes 600, 700 and 800, respectively, in some implementations, processes 600, 700 and 800 may include additional blocks, fewer blocks, different blocks, or differently arranged blocks than those depicted in FIGS. 6, 7, and 8. For explanatory purposes, the steps of processes 600, 700 and 800 are described herein as occurring in serial, or linearly. However, multiple instances of processes 600, 700 and 800 may occur in parallel, in a different order, simultaneously, quasi-simultaneously or overlapping in time.

### Hardware Overview

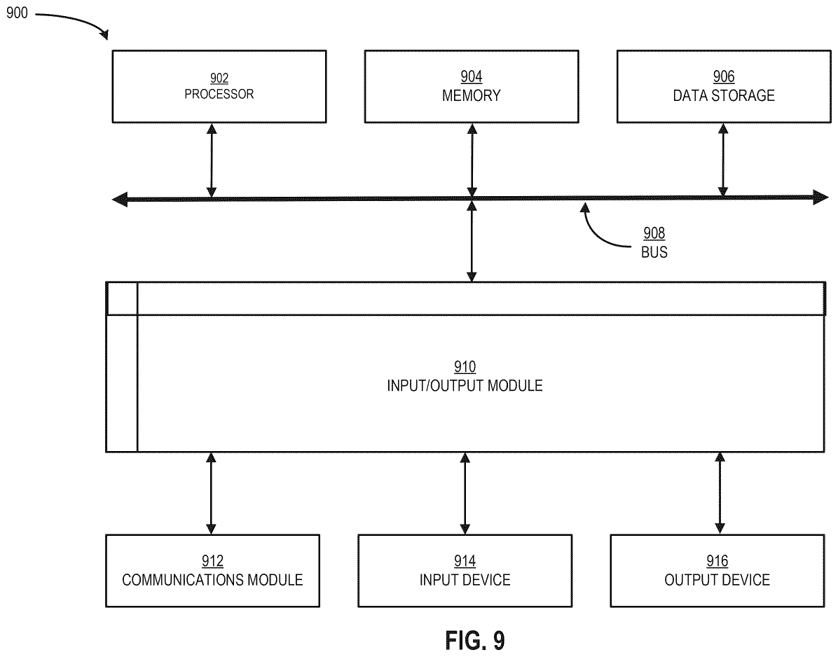

FIG. 9 is a block diagram illustrating an exemplary computer system 900 with which aspects of the subject technology may be implemented, according to certain aspects of the present disclosure. In certain aspects, computer system 900 may be implemented using hardware or a combination of software and hardware, either in a dedicated server, or integrated into another entity, or distributed across multiple entities. Computer system 900 may include a desktop computer, a laptop computer, a tablet, a phablet, a smartphone, a feature phone, a server computer, or otherwise. A server computer may be located remotely in a data center or be stored locally.

Computer system 900 may include a bus 908 or other communication mechanism for communicating information, and a processor 902 (for example, processors 212) coupled with bus 908 for processing information. By way of example, computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 900 may include, in addition to hardware, code that creates an execution environment for the computer program in question, for example, code that constitutes processor firmware, a protocol stack, a database management system, an operating system, or a combination of one or more of them stored in an included memory 904 (for example, memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. Processor 902 and memory 904 may be supplemented by, or incorporated in, special purpose logic circuitry.

The instructions may be stored in memory 904 and implemented in one or more computer program products, for example, one or more modules of computer program instructions encoded on a computer-readable medium for execution by, or to control the operation of, computer system 900, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program may be deployed to be executed on one computer or on multiple computers that are located at one site or distributed across multiple sites and interconnected by a communication network. The processes and logic flows described in this specification may be performed by one or more programmable processors executing one or more computer programs to perform functions by operating on input data and generating output.

Computer system 900 may further include a data storage device 906 such as a magnetic disk or optical disk, coupled to bus 908 for storing information and instructions. Computer system 900 may be coupled via input/output module 910 to various devices. Input/output module 910 may be any input/output module. Exemplary input/output modules 910 may include data ports such as USB ports. Input/output module 910 may be configured to connect to communications module 912. Exemplary communications modules 912 (for example, communications modules 218) may include networking interface cards, such as Ethernet cards and modems. In certain aspects, input/output module 910 may be configured to connect to a plurality of devices, such as an input device 914 and/or an output device 916. Exemplary input devices 914 may include a keyboard and a pointing device, for example, a mouse or a trackball, by which a user may provide input to the computer system 900. Other kinds of input devices 914 may be used to provide for interaction with a user as well, such as a tactile input device, visual input device, audio input device, or brain-computer interface device. For example, feedback provided to the user may be any form of sensory feedback, for example, visual feedback, auditory feedback, or tactile feedback; and input from the user may be received in any form, including acoustic, speech, tactile, or brain wave input. Exemplary output devices 916 may include display devices, such as an LCD (liquid crystal display) monitor, for displaying information to the user.

According to one aspect of the present disclosure, the client device and the server may be implemented using computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 may cause processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, for example, a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system may be interconnected by any form or medium of digital data communication, for example, a communication network. The communication network (for example, network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 900 may include clients and servers. A client and server may be generally remote from each other and typically interact through a communication network. The relationship of client and server arises by virtue of computer programs running on the respective computers and having a client-server relationship to each other. Computer system 900 may be, for example, and without limitation, a desktop computer, laptop computer, or tablet computer. Computer system 900 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein may refer to any medium or media that participates in providing instructions to processor 902 for execution. Such a medium may take many forms, including, but not limited to, non-volatile media, volatile media, and transmission media. Non-volatile media may include, for example, optical or magnetic disks, such as data storage device 906. Volatile media may include dynamic memory, such as memory 904. Transmission media may include coaxial cables, copper wire, and fiber optics, including the wires forming bus 908. Common forms of machine-readable media may include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, a “query” may refer to a computational element maintained by a perception system to represent information associated with an environment or a portion thereof. A query may include one or more parameters that encode spatial, semantic, temporal, or contextual information, and may be updated, propagated, combined, or otherwise processed based on sensor data, learned representations, or system state to support generation of one or more scene representations and/or other perception outputs.

As used herein, an automated vehicle is a vehicle including at least one automation system under the control of the vehicle rather than the driver of the vehicle. The Society of Automotive Engineers (SAE) has identified six levels of automation ranging from Level 0 (a human driver is at the control of the driving task even when the vehicle is equipped with warning or intervention systems (for example, for vehicle braking or lane keeping)) through Level 6 (a vehicle performs all driving tasks, in any environment and under all conditions under which a human driver could perform, also referred to as an autonomous vehicle or a fully autonomous vehicle). Some automated vehicles include an Advanced Driver Assistance System (ADAS), a system that automates specific driving features, such as forward collision warning, automatic emergency braking (for example, should an object fall off a preceding vehicle or a pedestrian enter the road), lane departure warning, lane keeping assistance, blind spot warning, or adaptive cruise control (that is, keeping a specified distance from a preceding car during cruise control operation), and requires a human to handle tasks that the ADAS does not support. Some automated vehicles are able to communicate with other automated vehicles or a remote server, for example to obtain or share updated or real-time traffic, weather, and other information.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112(f), unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in any claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method claims or clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

It should be understood that the original applicant herein determines which technologies to use and/or productize based on their usefulness and relevance in a constantly evolving field, and what is best for the original applicant and its users. Accordingly, it may be the case that the systems and methods described herein have not yet been and/or will not later be used and/or productized by the original applicant. It should also be understood that implementation and use, if any, by the original applicant, of the systems and methods described herein are performed in accordance with the privacy policies of the original applicant. These policies are intended to respect and prioritize user privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the privacy settings or preferences of the user. It should also be understood that the original applicant intends that the systems and methods described herein, if implemented or used by other entities, be in compliance with privacy policies and practices that are consistent with the objective of the original applicant to respect user privacy.

What is claimed is:

1. A computer-implemented method for generating semantic scene representations using sparse three-dimensional queries, the method comprising:
receiving, at a first timestep, multi-camera image data captured from a plurality of cameras that observe a three-dimensional scene;
accessing a queue of previously generated sparse three-dimensional queries propagated from one or more previous timesteps preceding the first timestep, wherein each previously generated sparse three-dimensional query includes a query location and a latent feature representation;
forming, based on the previously generated sparse three-dimensional queries, a plurality of current sparse three-dimensional queries representing the three-dimensional scene at the first timestep;
iteratively refining, based on the multi-camera image data and the previously generated sparse three-dimensional queries, the plurality of current sparse three-dimensional queries;
determining, based on the plurality of current sparse three-dimensional queries, a plurality of three-dimensional Gaussian primitives;
generating, based on the plurality of three-dimensional Gaussian primitives, a semantic representation of the three-dimensional scene; and
propagating at least a subset of the plurality of current sparse three-dimensional queries to the queue of the previously generated sparse three-dimensional queries for a second timestep.

2. The computer-implemented method of claim 1, further comprising:
compensating for an observer motion by transforming one or more query locations of the previously generated sparse three-dimensional queries from respective coordinate frames associated with timesteps of the previously generated sparse three-dimensional queries into a coordinate frame associated with the first timestep.

3. The computer-implemented method of claim 1, wherein:
forming the plurality of current sparse three-dimensional queries includes combining the previously generated sparse three-dimensional queries with one or more newly initialized sparse three-dimensional queries for the first timestep; and
the one or more newly initialized sparse three-dimensional queries are initialized at learnable or predefined query locations within a region of interest of the three-dimensional scene.

4. The computer-implemented method of claim 1, wherein determining the plurality of three-dimensional Gaussian primitives includes:
deriving, for each current sparse three-dimensional query, a query location offset, a query opacity, and multiple three-dimensional Gaussian primitives.

5. The computer-implemented method of claim 4, wherein determining the multiple three-dimensional Gaussian primitives includes:
computing, for each of the multiple three-dimensional Gaussian primitives, (i) a Gaussian location including a sum of the query location, the query location offset, and a per-Gaussian location offset, and (ii) a Gaussian opacity including a product of the query opacity and a per-Gaussian opacity factor.

6. The computer-implemented method of claim 1, wherein:
each three-dimensional Gaussian primitive includes semantic class information associated with a region of the three-dimensional scene; and
a first three-dimensional Gaussian primitive and a second three-dimensional Gaussian primitive derived from a same sparse three-dimensional query have a common semantic class label.

7. The computer-implemented method of claim 1, wherein generating the semantic representation of the three-dimensional scene includes:
generating a three-dimensional voxel-based semantic representation by splatting the plurality of three-dimensional Gaussian primitives to a voxel grid, wherein the voxel grid includes a plurality of voxel locations; and
computing, for each voxel location, (i) an occupancy probability, and (ii) a semantic class distribution based on contributions of one or more three-dimensional Gaussian primitives of the plurality of three-dimensional Gaussian primitives that influence the voxel location.

8. The computer-implemented method of claim 7, wherein determining the occupancy probability for each voxel location includes:
weighting an occupancy contribution of at least one of the three-dimensional Gaussian primitives by an opacity value associated with the at least one of the three-dimensional Gaussian primitives.

9. The computer-implemented method of claim 7, wherein splatting the plurality of three-dimensional Gaussian primitives to the voxel grid includes:
partitioning the voxel grid into a plurality of voxel blocks; and
loading, for each voxel block, parameters of one or more three-dimensional Gaussian primitives that influence voxel locations within the voxel block into a memory accessible for reuse when determining contributions for multiple voxel locations in the voxel block.

10. The computer-implemented method of claim 1, wherein propagating at least the subset of the plurality of current sparse three-dimensional queries includes:
selecting, based at least in part on one or more query opacities of the plurality of current sparse three-dimensional queries, the subset of the plurality of current sparse three-dimensional queries.

11. The computer-implemented method of claim 10, wherein selecting the subset includes:
enforcing a minimum spatial separation between the subset of the plurality of current sparse three-dimensional queries selected for propagation.

12. The computer-implemented method of claim 1, further comprising:
determining, for each current sparse three-dimensional query, a query velocity representing motion of a corresponding region of the three-dimensional scene across successive timesteps.

13. The computer-implemented method of claim 12, wherein propagating at least the subset of the plurality of current sparse three-dimensional queries includes:
updating, based at least in part on one or more query velocities of the subset of the plurality of current sparse three-dimensional queries, one or more three-dimensional query locations of the subset of the plurality of current sparse three-dimensional queries to generate propagated sparse three-dimensional queries for the second timestep.

14. A system, comprising:
one or more processors; and
one or more memories coupled to at least one of the one or more processors, wherein the one or more memories comprise computer-readable program instructions, which when executed by at least one of the one or more processors, cause the system to:
receive, at a first timestep, multi-camera image data captured from a plurality of cameras that observe a three-dimensional scene;
access a queue of previously generated sparse three-dimensional queries propagated from one or more previous timesteps preceding the first timestep, wherein each previously generated sparse three-dimensional query includes a query location and a latent feature representation;
form, based on the previously generated sparse three-dimensional queries, a plurality of current sparse three-dimensional queries representing the three-dimensional scene at the first timestep;
iteratively refine, based on the multi-camera image data and the previously generated sparse three-dimensional queries, the plurality of current sparse three-dimensional queries;
determine, based on the plurality of current sparse three-dimensional queries, a plurality of three-dimensional Gaussian primitives;
generate, based on the plurality of three-dimensional Gaussian primitives, a semantic representation of the three-dimensional scene; and
propagate at least a subset of the plurality of current sparse three-dimensional queries to the queue of the previously generated sparse three-dimensional queries for a second timestep.

15. The system of claim 14, wherein the computer-readable program instructions that cause the system to determine the plurality of three-dimensional Gaussian primitives include instructions that cause the system to:
derive, for each current sparse three-dimensional query, a query location offset, a query opacity, and multiple three-dimensional Gaussian primitives; and
compute, for each of the multiple three-dimensional Gaussian primitives, (i) a Gaussian location including a sum of the query location, the query location offset, and a per-Gaussian location offset, and (ii) a Gaussian opacity including a product of the query opacity and a per-Gaussian opacity factor.

16. The system of claim 14, wherein the computer-readable program instructions that cause the system to generate the semantic representation of the three-dimensional scene include instructions that cause the system to:
generate a three-dimensional voxel-based semantic representation by splatting the plurality of three-dimensional Gaussian primitives to a voxel grid, wherein the voxel grid includes a plurality of voxel locations.

17. The system of claim 16, wherein the computer-readable program instructions that cause the system to splat the plurality of three-dimensional Gaussian primitives to the voxel grid include instructions that cause the system to:
compute, for each voxel location, (i) an occupancy probability, and (ii) a semantic class distribution based on contributions of one or more three-dimensional Gaussian primitives of the plurality of three-dimensional Gaussian primitives that influence the voxel location;
partition the voxel grid into a plurality of voxel blocks; and
load, for each voxel block, parameters of one or more three-dimensional Gaussian primitives that influence voxel locations within the voxel block into a first memory of the one or more memories accessible for reuse when determining contributions for multiple voxel locations in the voxel block.

18. The system of claim 14, wherein the computer-readable program instructions that cause the system to propagate at least the subset of the plurality of current sparse three-dimensional queries include instructions that cause the system to:
select, based at least in part on one or more query opacities of the plurality of current sparse three-dimensional queries, the subset of the plurality of current sparse three-dimensional queries; and
enforce a minimum spatial separation between the subset of the plurality of current sparse three-dimensional queries selected for propagation.

19. The system of claim 14, wherein the computer-readable program instructions, when executed by the at least one of the one or more processors, further cause the system to:
determine, for each current sparse three-dimensional query, a query velocity representing motion of a corresponding region of the three-dimensional scene across successive timesteps; and
update, based at least in part on one or more query velocities of the subset of the plurality of current sparse three-dimensional queries, one or more three-dimensional query locations of the subset of the plurality of current sparse three-dimensional queries to generate propagated sparse three-dimensional queries for the second timestep.

20. A non-transitory computer-readable storage medium including computer-readable instructions embodied therein, which when executed by one or more processors, cause a computer system to:
receive, at a first timestep, multi-camera image data captured from a plurality of cameras that observe a three-dimensional scene;
access a queue of previously generated sparse three-dimensional queries propagated from one or more previous timesteps preceding the first timestep, wherein each previously generated sparse three-dimensional query includes a query location and a latent feature representation;
form, based on the previously generated sparse three-dimensional queries, a plurality of current sparse three-dimensional queries representing the three-dimensional scene at the first timestep;
iteratively refine, based on the multi-camera image data and the previously generated sparse three-dimensional queries, the plurality of current sparse three-dimensional queries;
determine, based on the plurality of current sparse three-dimensional queries, a plurality of three-dimensional Gaussian primitives;
generate, based on the plurality of three-dimensional Gaussian primitives, a semantic representation of the three-dimensional scene; and
propagate at least a subset of the plurality of current sparse three-dimensional queries to the queue of the previously generated sparse three-dimensional queries for a second timestep.
